(19) United States
(12) Patent Application Publication
(10) Pub. No.: US 2026/0220502 A1
(43) Pub. Date: Jul. 30, 2026

(54) Accelerating Inductive Learning In Description Logic

(71) Applicant: KING SAUD UNIVERSITY, RIYADH (SA)

(72) Inventor: Eyad Abdullah Algahtani, RIYADH (SA)

(21) Appl. No.: 19/041,058

(22) Filed: Jan. 30, 2025

(51) Int. Cl. G06N 5/04; G06N 5/02

(52) U.S. Cl. CPC G06N 5/04; G06N 5/02

(57) ABSTRACT

Hardware-based acceleration of computer operations is performed using Description Logic (DL) language inductive logic programming (ILP) instructions as logic-based rules or textual-like descriptions, in a form capable of interpretation by both humans and machines. A knowledge base interpretable by Inductive Logic Programming (ILP) and a set of concept axioms that enforces a set of logic-based constraints on the knowledge base establishing reasoning tasks on the knowledge base using the ILP are selected, and a hardware configuration implements the established reasoning tasks through a hardware implementation to perform a hypothesis evaluation task. The outputs of DL operations are represented as the reasoning tasks for a given DL hypothesis as a logical matrix, so that each matrix represents an aspect of the DL knowledge base to provide a results matrix representing the outputs of DL operations for a given DL hypothesis.

### BACKGROUND

### Technical Field

The present disclosure is directed to a technique for improving the performance of hypothesis evaluation that uses Description Logic (DL) language in inductive logic programming (ILP).

### Background Art

The employment of machine learning (ML) techniques in embedded systems, has seen constant growth in recent years, especially for black box ML techniques (such as artificial neural networks, ANNs); however, despite the successful employment of ML techniques in embedded environments, their performance potential is constrained by the limited computing resources of their embedded computers. Several hardware based approaches were developed (e.g., using FPGAs and ASICs), to address the constraints of limited computing resources. Machine learning (ML) as an artificial intelligence (AI) technique, has been successfully used in many disciplines (to achieve a variety of benefits), such as in healthcare and in retail. Even though ML techniques have proven their viability and usefulness for real-world applications, the amount of data generated and used as the input for ML algorithms has grown to very large sizes in recent years. As a result, ML techniques struggle to learn from these large datasets and to produce output (i.e., ML models) within a reasonable time.

### SUMMARY

Hardware-based acceleration of computer operations is performed using Description Logic (DL) language in inductive logic programming (ILP) instructions for performing a hypothesis evaluation task. At least a subset of the instructions are expressed as logic-based rules or textual-like descriptions, in a form capable of interpretation by both humans and machines. A knowledge base interpretable by Inductive Logic Programming (ILP) is selected. A set of concept axioms enforces a set of logic-based constraints on the knowledge base, in which the logic-based constraints establish reasoning tasks on the knowledge base using the ILP. A hardware configuration is used to implement the established reasoning tasks through a hardware implementation, and the knowledge base and the set of concept axioms are used to perform the hypothesis evaluation task, which is executed through the hardware implementation.

In one particular implementation, outputs of DL operations are used as the reasoning tasks for a given DL hypothesis as a logical matrix. In a further implementation, outputs of DL operations used as the reasoning tasks for a given DL hypothesis are represented as a logical matrix, so that each matrix represents an aspect of the DL knowledge base. A results matrix represents the outputs of DL operations for a given DL hypothesis, in which the DL accesses a concepts matrix, and a results matrix provides an output storage configuration.

### BRIEF DESCRIPTION OF THE DRAWINGS

FIG. 1 is a flow diagram showing an overview for a typical ILP learning process.

FIG. 2 is a flow diagram illustrating the DL-based ILP learning process for a Michalski trains dataset.

FIG. 3 is a flow diagram showing classification of ILP performance improvement approaches.

FIG. 4 is a schematic block diagram showing a comparison between software-based and hardware based approaches on accelerating ML computations, showing characteristics of ML acceleration.

FIG. 5 is a flow diagram showing a non-limiting example of the accelerator's workflow for hypothesis evaluation.

FIGS. 6A-6C are schematic block diagrams showing HT-HEDL's knowledge representation. FIG. 6A shows knowledge representation matrixes. FIG. 6B shows mapping lookup tables. FIG. 6C shows memory address offset lookup tables.

FIG. 7 is a flow diagram showing an example of evaluating a DL hypothesis in HT-HEDL.

FIG. 8 is a schematic block diagram showing the accelerator's architecture, showing implementation of HT-HEDL's knowledge representation.

FIG. 9 is a schematic block diagram showing the relation and interface connections between the accelerator's components, describing the data and control connections between the components.

FIG. 10 is a flow diagram showing the workflow for computing conjunction/disjunction operations, using visualized C-like pseudocode.

FIG. 11 is a schematic block diagram showing the memory architecture for indvA and indvB caches.

FIG. 12 is a flow diagram showing the workflow for the BAU unit.

FIG. 13 is a flow diagram showing the workflow for computing existential and universal role restrictions.

FIG. 14 is a flow diagram showing the workflow for computing cardinality role restrictions.

FIG. 15 is a flow diagram showing the workflow for computing numeric restrictions.

FIG. 16 is a flow diagram showing the workflow for computing string restrictions.

FIG. 17 is a graphical presentation showing a visualization of experimental results on conjunction and disjunction operations.

FIG. 18 is a graphical presentation showing a visualization of experimental results on existential, universal, and cardinality (MIN and MAX) role restrictions.

FIG. 19 is a graphical presentation showing a visualization of experimental results on numeric (MIN and MAX) and string (EQUAL and NOT EQUAL) restrictions.

### DETAILED DESCRIPTION

### Overview

The present disclosure improves the performance for ILP on embedded environments. ILP is a powerful logic-based ML technique that uses logic programming to construct human-interpretable ML models, where those logic-based ML models are capable of describing complex and multi-relational concepts.

Various approaches have implemented ILP for learning. ILP learners in general and DL-based ILPs in particular, typically formulate the learning process as a search problem; an ILP learner typically has three inputs: the background knowledge (represented using a logic-based representation, e.g., DL), and the (positive and negative) learning examples. An ILP's search algorithm searches through the search space of possible hypotheses (also known as the hypothesis space), guided by a scoring function that guides the search towards a hypothesis or a set of solution hypotheses; that ideally, cover all positive examples and none of the negative examples. Since (a typical) ILP learner uses a search algorithm as its learning procedure, therefore ILP learning consist of two key steps:hypothesis search and hypothesis evaluation.

The present disclosure implements a hardware-based approach that accelerates the hypothesis evaluation task for ILPs in embedded environments, that uses Description Logic (DL) languages as their logic-based representation. In particular, the disclosure targets the ALCQ(D) language. According to experimental results (through an FPGA implementation), the disclosed approach has achieved speed increases up to 48.7-fold for a disjunction of 32 concepts on 100M individuals; where the baseline performance is the sequential CPU performance of the Raspberry Pi 4. For role and concrete role restrictions, the FPGA implementation achieved speed increases of up to 2.4-fold (for MIN cardinality role restriction on 1M role assertions); all FPGA implemented role and concrete role restrictions, have achieved similar speed increases. In the worst case scenario, the FPGA implementation achieved either a similar or slightly better performance to the baseline (for all DL operations); where worst case scenario results from using a small dataset such as: using conjunction and disjunction on <100 individuals, and using role and concrete (float/string) role restrictions on <100,000 assertions.

In the context of the present disclosure, one of those ML techniques is focused on inductive logic programming (ILP). ILP is a ML technique that uses logic programming (e.g., horn clauses) to describe both knowledge and models. A ML model in ILP, typically is expressed in the form of logic-based rules or textual-like descriptions, that can easily be interpreted by both humans and machines. ILP models are capable of constructing (logic-based) models that can describe multi-relational and complex concepts. In terms of real-world applications, ILP has been used in the aerospace industry for learning (logic-based) rules for diagnosing satellite temporal faults. In addition, ILP has been used in biochemistry for predicting the structure of chemical compounds. Moreover, ILP was used to learn the description of “25-34 years old” demographic from a retail dataset. Furthermore, other researchers also used ILP to learn user preferences from ordinal data.

ILP as one of the ML techniques struggle in the scalability aspect; especially since ILP algorithms (in many cases) are inherently sequential algorithms, which introduces major challenges for speeding up their computations. This ILP scalability challenge, has resulted in many approaches being developed to address these inherent deficiencies; however, many of these approaches (especially the ones based on parallel computing), rely on using software based solutions (e.g., CPUs and GPUs), and overlook the potential performance gains of hardware based solutions (e.g., FPGAs and ASICs). One key advantage of dedicated hardware designs (i.e., a hardware specifically designed for a particular purpose) is that they have much more parallel computing capabilities and consume much less power than software solutions. In other words, the number of parallel processing logic in CPUs and GPUs is fixed; while an FPGA (a common form of a hardware solution), has much more parallel processing capability that can be used (or configured) to improve performance. Even though FPGAs (as a hardware solution) consume much less power than software solutions (for the same computations), even more power efficiency can be obtained through an ASICs hardware solution. However, ASICs are more expensive to design and manufacture (as opposed to FPGAs).

The disclosed concept implements description logic and inductive logic programming. In a non-limiting example, a hardware-based approach is implemented. The approach explores the potential for hardware-based approaches to improve the performance of ILP algorithms; and to what degree those performance gains are (in comparison to baseline, i.e., sequential CPU execution). ILPs that employ description logic (DL) are targeted since their representation formalism provide expressive constructs capable of describing complex concepts, while at the same time, they have cheaper computational complexity (when compared to other expressive logics, such as first order logic).

Description logic (DL) is a family of logic formalism that are more expressive than propositional logic, and less expressive than first order logic (FOL). In many applications, DL has a sufficient level of expressivity, to describe complex and multi-relational concepts; such as describing the structure of carcinogenic chemical compounds. Due to DL's expressivity and cheaper computational complexity (as compared to FOL), DL has been used as the underlying knowledge representation for checking and ensuring the consistency of OWL (Web Ontology Language) knowledge bases. In addition, DL is also used for querying and deductive reasoning on OWL knowledge bases, in particular, the “OWL DL” variation. It is worth noting that some OWL variations may have (more expressive) constructs that are not supported by DL languages, such as “OWL Full”.

Terms used in the example embodiments are selected from currently widely used general terms when possible while considering the functions in the present disclosure. However, the terms may vary depending on the intention or precedent of a person skilled in the art, the emergence of new technology, and the like. Further, in certain cases, there are also terms arbitrarily selected by the applicant, and in these cases, the meaning will be described in detail in the corresponding descriptions. Therefore, the terms used in the present disclosure should be defined based on the meaning of the terms and the content of the present disclosure, rather than the simple names of the terms.

Throughout the specification, when a part is described as “comprising or including” a component, it does not exclude another component but may further include another component unless otherwise stated.

### Description Logic

Description logic (DL) is a family of logic formalism that are more expressive than propositional logic, and less expressive than first order logic (FOL). In many applications, DL has a sufficient level of expressivity, to describe complex and multi-relational concepts; such as describing the structure of carcinogenic chemical compounds. Due to DL's expressivity and cheaper computational complexity (as compared to FOL), DL has been used as the underlying knowledge representation for checking and ensuring the consistency of OWL (Web Ontology Language) knowledge bases. In addition, DL is also used for querying and deductive reasoning on OWL knowledge bases, in particular, the “OWL DL” variation. It is worth noting, that some OWL variations may have (more expressive) constructs that are not supported by DL languages, such as “OWL Full”.

As a logic-based representation, DL describes a knowledge base using instances (individuals), concepts and roles; where a DL knowledge base consists of an A-Box (assertions box) and a T-Box (terminological box). An A-Box contains the assertions (or ground facts), which in DL, can be unary and binary assertions. A unary (concept) assertion takes the form a:C where a is an individual and C is concept. A binary (role) assertion takes the form (a,b):r, by which r is the role, and both a and b are individuals; where a is the subject and b is the object of the role assertion. Examples for unary and binary assertions, can be seen in Table 1:

TABLE 1
Examples for ABox assertions.

| Assertion type | Example |
|---|---|
| Unary assertion | i123:Person |
| | abc456:House |
| | efg:Car |
| Binary assertion | (i123,abc456):livesIn |
| | (i123,efg):drives |
| | (abc456,1200.34):price |

In Table 1, i123 is a person, abc456 is a house, and efg is a car. In terms of binary assertions, according to the assertion (i123,abc456):livesIn, the individual i123 (a person) lives in the house abc456; where i123 is the assertion's subject, and abc456 is the assertion's object. For the assertion (i123,efg):drives, the individual i123 drives the car efg. The DL expression (abc456,1200.34):price is an example of a concrete role assertion, which means that the individual abc456 (a house) has a price of 1200.34 money units. Role assertions connects individuals to individuals, whereas concrete role assertions connect individuals to values (e.g., Boolean, numeric, string), assigned to a particular concrete role.

In terms of the TBox, the TBox provides a set of concept axioms (logic-based constraints), that enforces a set of constraints on the knowledge base; these (logic-based) constraints are also used for reasoning tasks on the knowledge base, such as checking the consistency of the knowledge base. There are two axioms in the TBox: concept inclusion, and concept definition. In concept inclusion (C [symbol] D), C is a type (or sub concept) of D; concept inclusion axioms are typically used to set a hierarchy of concepts in the knowledge base. For example, the axiom Man [symbol] Person, means that a Man is a type of a Person. Moreover, the Tbox contains the T (top concept) and ⊥ (bottom concept). All individuals are (implicit) members of the T concept, and all concepts are sub concepts of the T concept. On the other hand, the ⊥ concept has no individuals.

In terms of concept definition (C≡D), any individual who is a member of the concept D is also a member of the concept C; the concept D can be either a simple concept (e.g., a Person), or a complex concept (e.g., Female∃ teaches (Math)). For example, the concept definition FemaleMathTeacher ≡Femalen∃teaches(Math), means that any individual who is a female that teaches math is a member of the FemaleMathTeacher complex concept. A complex concept (or a DL hypothesis) is built using DL constructors (or operators); these DL constructors are also used for building queries, which are then used to retrieve data from the knowledge base. See Table 2 for examples on DL constructors.

TABLE 2
Examples for DL constructors.

| | | |
|---|---|---|
| Constructor name | Syntax | Example |

Concept constructors

| | | |
|---|---|---|
| Conjunction | C Π D | Animal Π Small |
| Disjunction | C [symbol] D | Male [symbol] Female |
| Negation | ¬C | ¬Person |

Role constructors

| | | |
|---|---|---|
| Existential restriction | ∃r (D) | ∃drives (Car) |
| Value (universal) restriction | ∀r (D) | ∀teaches (Art) |
| MAX number restriction | ≤n r (C) | ≤ 2 hasChild (Person) |
| MIN number restriction | ≥n r (C) | ≥ 3 hasChild (Doctor) |

Concrete role constructors

| | | |
|---|---|---|
| EXACT restriction | d = v | name = ”Craig” |
| MAX number restriction | d ≤ v | temprature ≤ 60.02 |
| MIN number restriction | d ≥ v | temprature ≥ 20 |

In Table 2, the DL expression AnimalSmall refers to all individuals that have concept memberships in both Animal and Small concepts; that is, individuals that are small animals. For Male [symbol] Female, it refers to individuals that are either male or female; that is, having a concept membership in at least one of those concepts. In terms of role constructors, ∃drives( ) refers to any individual that drives at least one car. The ∇teaches( ) refers to any individual that either only teaches art, or not teaching at all. For number restrictions, ≤2hasChild(person) refers to any individual that have at most two children (that are members of the Person concept); the DL hypothesis ≥3 hasChild(Doctor), refers any to any individual that have at least 3 children that are doctors (that is, these children are also members of the Doctor concept).

In concrete role constructors, the EXACT restriction name=“Craig” refers to any individual that has a concrete role assertion, with the value “Craig” in the concrete role name. For (concrete role) MAX number restriction, temperature ≤60.02 will refer to any individual that has a concrete role assertion with a temperature value ≤60.02; the MIN number restriction (temperature ≥20), follow the same approach as the MAX number restriction, though its uses the operator≥operator (instead of ≤).

In terms of DL languages (or variations), there are many variations of DL, some of which are more expressive than others (though with increased computational complexity). DL languages are typically described by a set of predefined symbols, where each symbol describe which DL constructor(s) are supported. For example, this article targets accelerating the computations for the ALCQ(D) DL language, which supports all DL constructors described in Table 2; the symbols describing this DL language are as follows:

$$ALC : - Conjunction ( C ⊓ D ) , Disjunction ( C \text{?} D ) - Negation ( ¬ C ) - Existential restriction ( ∃ r ( D ) ) , Value restriction ( ∀ r ( D ) )$$

$$Q : - Qualified number restrictions ( \leq n r ( C ) , \geq n r ( C ) , and = n r ( C ) )$$

$$The superscript ( D ) : - The use of concrete roles ( including concrete role restrictions )$$

An example for a less expressive DL language (than ALCQ(D)) is the ALC language which support fewer DL constructors. More details regarding the symbols that describes DL languages are available in Baader, F. et al. (2017) ‘An introduction to description logic’, Cambridge: Cambridge University Press, at p. 232.

It is worth noting, that in more expressive DL languages, an RBox (relational box) may be incorporated (in addition to TBox and ABox). The RBox has axioms that govern the roles of the knowledge base; similar to the TBox, which has axioms that governs the concepts of the knowledge base.

### Inductive Logic Programming

ILP learners in general and DL-based ILPs in particular, typically formulate the learning process as a search problem; an ILP learner typically has three inputs: the background knowledge (represented using a logic-based representation, e.g., DL), and the (positive and negative) learning examples. An ILP's search algorithm searches through the search space of possible hypotheses (also known as the hypothesis space), guided by a scoring function that guides the search towards a hypothesis or a set of solution hypotheses; that ideally, cover all positive examples and none of the negative examples. Since (a typical) ILP learner uses a search algorithm as its learning procedure, therefore ILP learning consist of two key steps:hypothesis search and hypothesis evaluation.

In hypothesis search, an ILP learner generates a set of potential (candidate) hypotheses using a refinement operator. The refinement operator is a procedure employed by ILP learners to: generate new candidate hypotheses by refining (modifying) existing candidate hypotheses, and also to generate completely new (not previously generated) candidate hypotheses; the refinement operator's exact procedure for generating candidate hypotheses is typically different from one ILP learner to another. The generated hypotheses (also known as refinements) by the refinement operator must be in the same logic representation as the background knowledge; for example, given a background knowledge represented using the ALCQ(D) DL variation, the generated refinements must also satisfy the constraints of the ALCQ(D) DL language. In addition, a refinement operator has a well-defined hypothesis language, which is the set of supported constructors (or operators) and other (user-provided constraints) that affect how the refinement operator can use construct hypotheses. For example (in the context of DL), assuming a refinement operator with a hypothesis language that only allowed to use conjunction () and disjunction ( [symbol] ) DL constructors, the refinement operator will only be capable of generating hypotheses that uses combinations of those DL constructors—even if the background knowledge is described using the ALCQ(D) language. Moreover, in terms of user-provided constraints, sometimes the user may add constraints to the hypothesis language (based on domain-knowledge about the given ILP learning problem) to guide the hypothesis search towards more promising (candidate) hypotheses. All ILPs employ a form of a refinement operator to generate candidate hypotheses; however, the exact procedure for the refinement operator can be different from one ILP to another.

In the second key step in ILP learning (hypothesis evaluation), each hypothesis generated during the hypothesis search process is then evaluated by a scoring function to determine whether the given hypothesis should be expanded further, or simply to be discarded. During the evaluation of hypotheses, the covered positive and negative examples are computed for each of the generated hypotheses; for each hypothesis, the computed examples coverage are used to compute the evaluation score for the given hypothesis. The hypothesis with the most promising score (e.g., highest accuracy) will be expanded further, by the hypothesis search step (through its refinement operator).

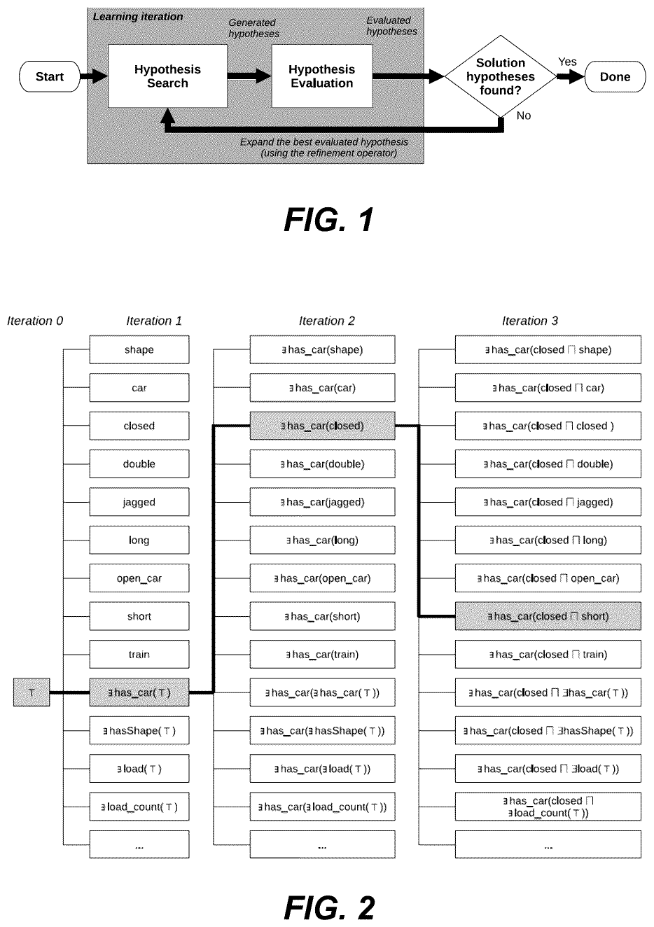

FIG. 1 is a flow diagram showing an overview for a typical ILP learning process. Hypothesis search and evaluation steps are sequentially repeated, where a single sequence of hypothesis search and evaluation is known as a single learning iteration. In many cases, when more iterations are passed, usually better hypotheses are being generated. When the learning stop condition is satisfied, which can be when the search algorithm finds a generated hypothesis that cover all positives and zero negatives—that is, an ideal scenario; however, in most ILP learning scenarios (dealing with real-world datasets), the learning usually terminates when a good-enough hypothesis is found (that satisfy minimum acceptable accuracy, for example). Moreover, the ILP learning can also be terminated when a predefined learning timeout has been reached.

To demonstrate the DL-based ILP learning process, the DL version of Michalski trains dataset available in the DL-Learner's repository may be used. The DL-Learner is regarded as the state of the art in the DL-based ILP literature. “Michalski trains” is a well-known dataset in the ILP literature, which describes 10 trains and their heading directions (5 eastbound and 5 westbound trains). The ILP learning goal of Michalski trains dataset is to learn a DL-based description of eastbound trains. The concepts and roles of Michalski's dataset and its ILP learning examples, are described in Table 3:

TABLE 3
The details for the DL version of Michalski trains dataset.

| | | Learning examples | |
|---|---|---|---|
| | | Positive examples | Negative examples |
| Concepts | Roles | (set of individuals) | (set of individuals) |
| shape | has_car | east1 | west6 |
| car | has_shape | east2 | west7 |
| closed | load | east3 | west8 |
| double | load_count | east4 | west9 |
| jagged | wheels | east5 | west10 |
| long | | | |
| open_car | | | |
| short | | | |
| train | | | |

In Table 3, all trains are members of the train concepts, and all train cars are members of the car concept. The cars are linked to their corresponding trains through the has_car role. To describe the shape of a train car, the hasShape role is used connect car to a particular shape individual (circle, elipse, hexagon, rectangle, triangle, or u_shaped). Similar to the hasShape role, the load role links a car to shape individuals. For the load_count and wheels roles, they link a car to one of the following individuals (zero, one, two, or three). The concepts (closed, double, jagged, long, open_, and short) are used on car individuals, to provide more features on train cars.

FIG. 2 is a flow diagram illustrating the DL-based ILP learning process for Michalski trains dataset. This provides a solution path for learning a DL hypothesis that describes Michalski's eastbound trains, using a simple refinement operator. The ILP learning starts by expand the T concept using the learner's refinement operator. The generated refinements (candidate DL hypotheses) are than evaluated against the dataset and the learning examples, to count the number of covered positives and negatives for each generated refinement. The generated refinement with the best coverage (e.g., highest accuracy), will be expanded in the next iteration; in iteration 1, the generated refinement with best coverage is ∃has_car (T). After expanding the ∃has_car (T) refinement, several new refinements are generated, among which is the ∃has_car (closed) refinement. Since the ∃has_car (closed) refinement has the best examples coverage, it will be expanded in the next iteration. The result of expanding the ∃has_car (closed) refinement, results in generating several refinements, including the ∃has_car (closedsh) refinement, which means that any train that has at least one car that is both closed and short. After evaluating the ∃has_car (closedsh) refinement, the refinement has a 100% accuracy; that is, the refinement matches all eastbound trains (positive examples) and none of the westbound trains (negative examples). After finding a refinement with a 100% accuracy, the ILP learning is then terminated. The (DL-based) ILP learning on Michalski trains, resulted in the following refinement path: T→∃has_car ()→∃has_car (closed) →∃has_car (closedsh).

After reviewing the ILP performance improvement literature, and comparing the advantages and disadvantages for software-based and hardware-based approaches; and also discussing the motivation for using hardware-based approaches for improving ILP performance in embedded environments. Therefore, according to the present disclosure, a hardware design for accelerating hypothesis evaluation computations for DL-based ILPs in embedded environments is implemented. The disclosed technique provides two key contributions. First, it will explore the potential for hardware-based approaches, on improving ILP performance in general, and ILP performance in embedded environments in particular—especially since the area of ILP performance improvement research (using hardware approaches) is rarely explored. Second, the disclosed hardware design will serve as an alternative method for accelerating ILP computations (over baseline, i.e., sequential CPU evaluation) on embedded environments; in addition to other existing acceleration methods for improving performance (over baseline), such as multi-core CPUs.

The disclosed hardware design can either be implemented in an FPGA or an ASIC; however, an FPGA implementation is used to evaluate the performance of the disclosed design. In a comparison between the disclosed accelerator design and the accelerator developed by the researchers in the disclosed accelerator targets improving the performance of hypothesis evaluation for DL-based ILPs in embedded environments; whereas, the researchers' Prolog accelerator target accelerating hypothesis evaluation for the traditional (FOL-based) ILP learners. The disclosed accelerator (in its current state) targets speeding up computations for a single hypothesis, while the researcher' saccelerator targets speeding up computations for a single hypothesis (through a single WAM), and multiple hypotheses (through multiple WAMs implemented on the same chip).

### Hardware Approach for Accelerating Inductive Learning in Description Logic

The disclosed technique functions as a hardware-based accelerator that accelerates hypothesis evaluation computations, for DL-based ILP learners. For example, a DL-based ILP may perform hypothesis search on the CPU (whether sequential or parallel search), and then a number of (candidate) hypotheses are generated—as a result of the hypothesis search. The task for evaluating these generated hypotheses is then offloaded to the accelerator (by the CPU); the accelerator evaluates the generated hypotheses; and then report their evaluation results to the host system. The disclosed accelerator is based on the algorithms presented in a development described as High-Throughput Hypothesis Evaluation in Description Logic (HT-HEDL), described in Algahtani, “HT-HEDL: High-Throughput Hypothesis Evaluation in Description Logic”, Journal of Latex Class Files, December 2024. HT-HEDL a software-based hypothesis evaluation accelerator. The present technique, the accelerator optimizes HT-HEDL's algorithms for hardware-based implementation.

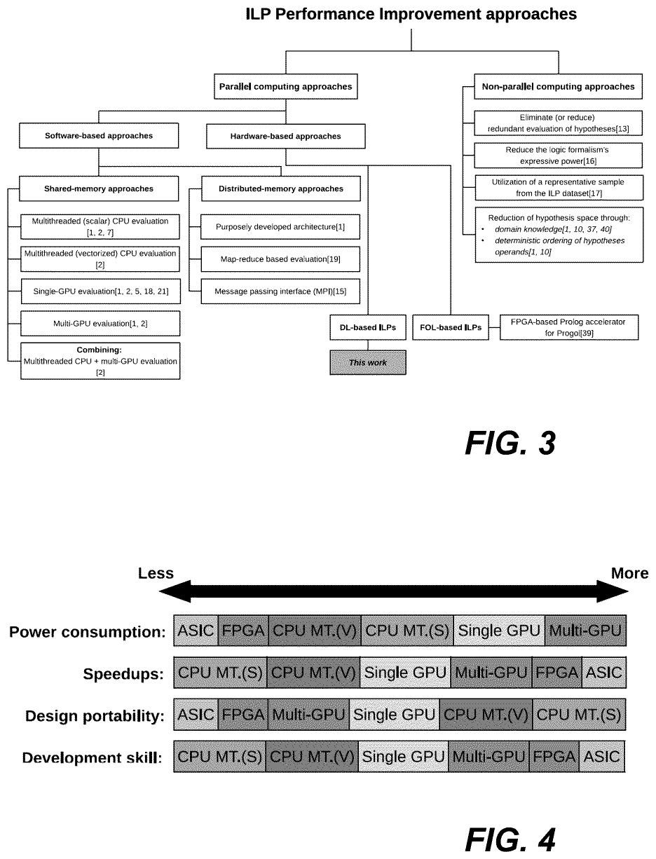

FIG. 3 is a flow diagram showing classification of ILP performance improvement approaches. First, some parallel approaches include other parallel approaches for improving performance. For example, the work in includes approaches for improving ILP performance using: both scalar and vectorized CPU multi-threading, single GPU, multi-GPU, and the combination of multi-GPU+(scalar/vectorized) CPU multi-threading. Second, some parallel approaches also incorporate some non-parallel approaches to further improve performance, such as in, which incorporated deterministic ordering of hypotheses operands (a non-parallel approach), with the aggregated performance of multi-core CPUs with multi-GPUs (a parallel approach). Third, all of the example approaches can be provided as software-based implementations, that is, they are designed and implemented as software which is then executed on one or more processors; where each processor can be a CPU or a GPU. In other words, no hardware-based approaches were proposed to improve ILP computations in general and hypothesis evaluation in particular—especially for DL-based ILPs. Moreover, all disclosed approaches target ILP performance improvement on personal computers and server computers. In other words, no approaches were specifically developed to improve ILP performance in embedded system environments, that have limited processing power and constrained power consumption; even though in recent years, more powerful embedded hardware are becoming available, such as single board computers (SBCs) like the Raspberry PI. There is also other embedded hardware with more powerful GPUs that are becoming available, such as NVIDIA's Jetson family.

In the context of ILP in embedded system environments, prior approaches for improving the performance of (DL-based) ILP learning on the Raspberry Pi 4, through a scalar multi-threaded CPU hypothesis evaluation; in addition to the parallel hypothesis search approach; however, these approaches are not hardware-based approaches, but rather software-based that relies heavily on speed increases achieved by limited computing power of embedded processors. Therefore, hardware-based approaches present as a good candidates for accelerating ILP computations in embedded system environments, because of several reasons. First, they have very high parallel computing capabilities. Second, they consume (relatively) less power (as opposed to multi-core CPUs and GPUs)—this is especially important for embedded environments, because they are inherently power constrained, and power-efficient processors are needed. Moreover, the research area for accelerating ILP learning using hardware-based approaches is an area which is rarely explored. Furthermore, hardware-based approaches were successfully used to accelerate other ML techniques such as neural networks.

FIG. 4 is a schematic block diagram showing a comparison between software-based and hardware based approaches on accelerating ML computations, showing characteristics of ML acceleration. First, scalar CPU multi-threading (“CPU MT.(S)”) is relatively the easiest acceleration method for accelerating computations; however, this method also provides the least performance speed increases. In many implementation cases (of this acceleration method), the vector/SIMD instruction set, available in modern CPUs, are typically ignored—this results in less efficient use of CPU's computing capabilities. On the other hand, in the second acceleration method which is vectorized CPU multithreading (“CPU MT.(V)”), will provide much higher performance gains than pure (scalar) multithreading; however, with two key disadvantages. First, the needed development skill is higher (than for scalar multithreading), because proper utilization of a CPU's vector instruction set, requires deep understanding of the CPU's architecture; moreover, some CPUs may have different vector instruction set, than other CPUs, e.g., SSE (Streaming SIMD Extensions) and AVX (Advanced Vector Extensions) for Intel and AMD CPUs, and Neon for ARM CPUs. The second disadvantage for vectorized CPU multithreading (especially with CPUs with large core counts) is that despite the much larger performance gains (than scalar multithreading); the CPU's cores together with each core's vector instructions will saturate the memory bandwidth, which will impose an upper limit on how much performance speed increases can be achieved.

In third and fourth acceleration methods (single GPU and multi-GPU, respectively), GPU-based methods typically introduce significant performance gains (as opposed to CPU-based methods)—especially for highly parallel computations; however, GPUs are designed for highly parallel computations, and typically have very poor scalar (sequential) performance (as opposed to CPU-based methods). Therefore, to improve computing performance through GPUs, the computation task has to be carefully engineered (or re-engineered); this engineering effort require more knowledge about GPUs' computing architectures and algorithm design, in order to take advantage of GPUs' highly parallel computing resources. Even though GPU-based method provides significant speed increases, they are typically more expensive and consume more power than CPUs—especially for high-end GPUs. In a multi-GPU environment, the computing power of GPUs are combined, which will result in more speed increases being achieved; though, with some major drawbacks. First, multi-GPU environments have the worst power consumption (in comparison with other acceleration methods). Second, multi-GPU environments require more development skill to design algorithms, which take advantage of those GPUs' computing capabilities which cover many challenges such as: distributing appropriate amount of computation workloads to each GPU, and managing (and coordinating) the work of those GPUs. In the third drawback for multi-GPU environments, there is an upper limit on how many GPUs can be installed in a single machine.

In fifth and sixth acceleration methods (FPGAs and ASICs, respectively), a major advantage for hardware-based methods is the very low power consumption (which is more pronounced in ASICs)—this is especially useful for embedded system environments. Moreover, hardware-based methods are more efficient (in terms of both: power consumption, and computing resources utilization) than software-based methods, because a dedicated hardware architecture is designed to fit a particular ML task. Due to this dedicated hardware design, hardware-based methods tend to provide significant speed increases with lower latency (as opposed to software-based methods)—especially for highly parallel computations (similar to GPUs). In comparison with GPUs, GPUs have a limited number of parallel data processing units, whereas a hardware design can be made (in either FPGA or ASIC), to have a much larger number parallel data processing units; this implemented hardware design will result in more computing performance being achieved; despite (in the case of an FPGA) having a much lower clock (in the MHz range), than a typical GPU (in the GHz range). The major drawback for hardware-based methods is the high development skill required to design and implement hardware designs; which is in the case of FPGAs is meeting timing constraints and proper utilization of an FPGA's resources. In the case of ASICs, they have very high manufacturing costs (even though they are computationally more powerful than FPGAs). As a result, the most common form of hardware-based acceleration method is FPGAs due to their flexibility (in terms of simply programming the hardware design into the FPGA chip), and also due to FPGAs much cheaper cost than ASICs.

Based on expected ILP performance improvements, a hardware design for accelerating hypothesis evaluation computations for DL-based ILPs in embedded environments was selected. The disclosed design provides two key contributions: First, it exhibits the potential for hardware-based approaches, on improving ILP performance in general, and ILP performance in embedded environments in particular—especially since the area of ILP performance improvement research (using hardware approaches) is rarely explored. Second, the hardware design serves as an alternative method for accelerating ILP computations (over baseline, i.e., sequential CPU evaluation) on embedded environments; in addition to other existing acceleration methods for improving performance (over baseline), such as multi-core CPUs.

The disclosed hardware design can either be implemented in an FPGA or an ASIC; however, an FPGA implementation is used to evaluate the performance of the disclosed design. In a comparison between the disclosed accelerator design and the accelerator developed by the researchers in, the disclosed accelerator targets improving the performance of hypothesis evaluation for DL-based ILPs in embedded environments; whereas, the researchers' Prolog accelerator target accelerating hypothesis evaluation for the traditional (FOL-based) ILP learners. The disclosed accelerator (in its current state) targets speeding up computations for a single hypothesis, while the researchers' accelerator targets speeding up computations for a single hypothesis (through a single WAM), and multiple hypotheses (through multiple WAMs implemented on the same chip).

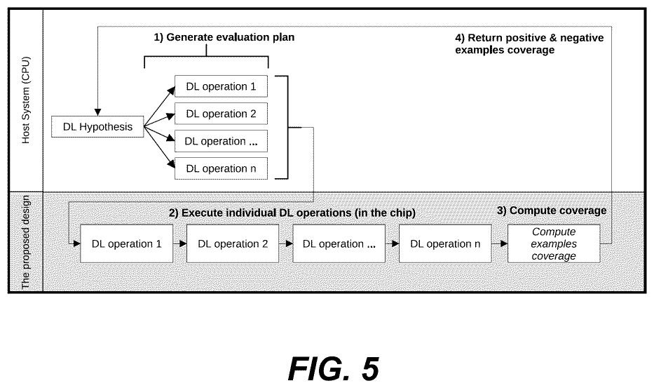

FIG. 5 is a flow diagram showing a non-limiting example of the accelerator's workflow for hypothesis evaluation. The host system (i.e., the CPU) generates an evaluation plan (described in next sections), that determines the computation sequence of DL operations, to evaluate the given hypothesis. Then, these individual DL operations are offloaded (in sequence) into the accelerator. The accelerator will compute the result for each received DL operation. Once all DL operations for the given hypotheses are computed, the accelerator will then compute the examples coverage (i.e., the covered positive and negative examples). The results for the examples coverage computations are then reported back to the host system.

In terms of supported DL operators, the accelerator speed up the computations for DL operators in the ALCQ(D) DL language. The reason for choosing this particular DL language is because it has expressive operators, suitable for constructing hypotheses that are expressive enough for many ILP learning scenarios. It is worth noting that using more expressive DL languages, especially when its high expressive capabilities are not needed (for a given ILP learning scenario), will result in: constructing hypotheses that are more computationally expensive to evaluate, and also resulting in much larger hypothesis space for (DL-based) ILP learners to explore. Large hypothesis space has the potential for negatively affecting the performance of ILP learners in general—because it will result in more child hypotheses being generated, from expanding a single parent hypothesis.

### Knowledge Representation

In terms of DL knowledge representation, the accelerator has a dedicated DDR memory for storing the DL knowledge base; the accelerator's DDR memory also store the positive and negative examples, which are needed to compute the examples coverage for hypotheses. For representing individuals, concepts, roles and concrete roles of the DL knowledge base; the accelerator uses the same knowledge representation as in the High-Throughput Hypothesis Evaluation in Description Logic (HT-HEDL), as indicated supra. HT-HEDL is a software-based approach that accelerates hypothesis evaluation for DL-based ILPs, at the level of a single hypotheses and at the level of multiple hypotheses. At the level of a single hypothesis, HT-HEDL can use scalar CPU multithreading, vectorized CPU multithreading, or single GPU; to accelerate the evaluation of a single hypothesis.

At the level of multiple hypotheses, HT-HEDL employs a capability-aware scheduler, which approximates the evaluation capabilities for each evaluation device (whether it is a CPU or a GPU) through a “probing query” (essentially, a dummy hypothesis). The computations for determining the evaluation capabilities for each evaluation device are performed only once (after the DL knowledge base is first loaded). For evaluating multiple hypotheses, HT-HEDL will assign hypotheses to all available evaluation devices, based on each device's (approximated) evaluation capabilities, where each device will evaluate its assigned hypotheses in parallel with other evaluation devices—thus, increasing hypothesis evaluation throughput (i.e., the number of evaluated hypotheses per unit of time).

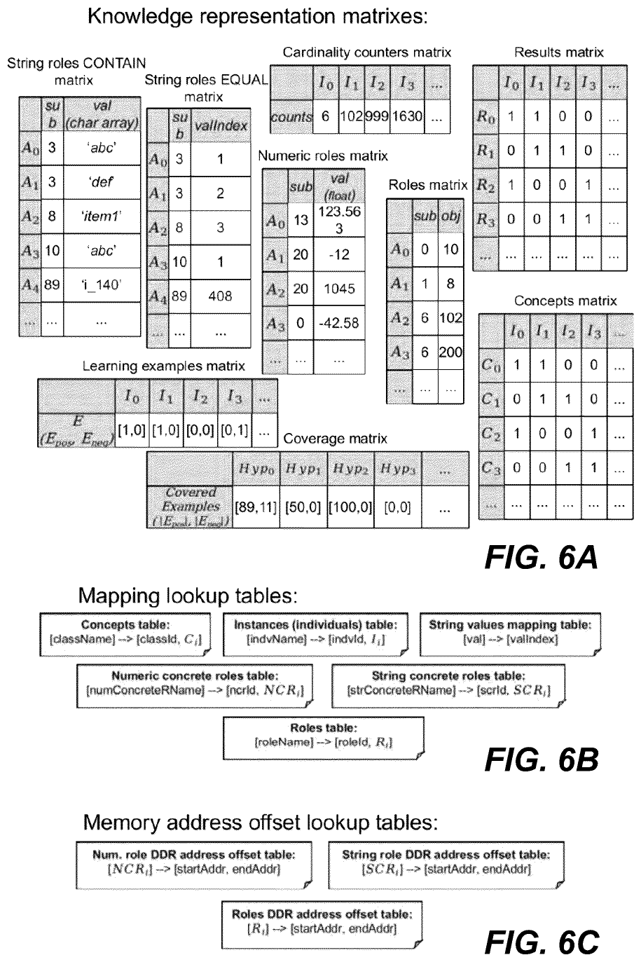

FIGS. 6A-6C are schematic block diagrams showing HT-HEDL's knowledge representation. FIG. 6A shows knowledge representation matrixes; FIG. 6B shows mapping lookup tables; and FIG. 6C shows memory address offset lookup tables.

In FIGS. 6A-6C, each matrix represents a certain aspect of the DL knowledge base. The concepts, roles, numeric roles, and string roles matrices; represents the concepts, roles, numeric concrete roles, and string concrete roles of the knowledge, respectively. In other words, the aforementioned matrices are used for representing the data of the DL knowledge base—in particular, the ABox. The results matrix represents the outputs of DL operations for a given DL hypothesis (after executing the hypothesis evaluation plan); the output of a DL operation is the list of covered individuals by the DL operation. The output of the final DL operation (in the evaluation plan) is then compared with the list of individuals in the learning examples matrix; the learning examples matrix represents the ILP learning examples, which are used to compute the number of positive and negative examples, covered by the given hypothesis. The cardinality counters matrix is used by cardinality role restrictions, to temporally store the number of matched individual objects per each individual subject, for a given role's assertions.

In terms of string CONTAIN and EQUAL matrices, they are both used to compute string concrete role restrictions; the CONTAIN matrix is used for string restrictions that finds a matching string assertion (for a given string role), where the assertion's value contains a specific string value. The EQUAL matrix is used for EQUAL string restrictions that find a matching string assertion, where the assertion's value is equal (or not equal) to a specific string value. In EQUAL string restrictions, HT-HEDL uses the numeric (integer) mappings of string values (in “String values mapping table”) for checking strings' equality; because equality comparisons on integers, are faster than equality comparisons on string values—especially in GPUs. In terms of the coverage matrix, the input for HT-HEDL is the list of input hypotheses (to be evaluated), and the output is the list of covered positive and negative examples for each of the input hypotheses; HT-HEDL stores the final hypothesis evaluation results (i.e., the examples coverage) for each input hypothesis, in the coverage matrix, where each index in the coverage matrix corresponds to a particular input hypothesis. The reason for HT-HEDL's matrix-based knowledge representation is because HT-HEDL is specifically designed (and optimized) for SIMD-based data processing such as: GPUs and vectorized CPU multithreading.

As shown in FIGS. 6A-6C, the mapping lookup tables are used to map the knowledge base's textual (string) data to numeric (integer) mappings, which are then used to populate HT-HEDL's matrices. In terms of the memory address offset lookup tables, HT-HEDL's sorts all assertions in the role, numeric role, and string role matrices; based on the role's (or concrete role's) ID in each of the those matrices—for more efficient memory access pattern. For example, all numeric role assertions in the numeric roles matrix, are sorted by numeric role IDs (NCRi); in other words, all numeric assertions that belong to a specific NCRi, are stored in continuous memory addresses, and their start and end DDR addresses, are stored in the “Num. role DDR address offset table”.

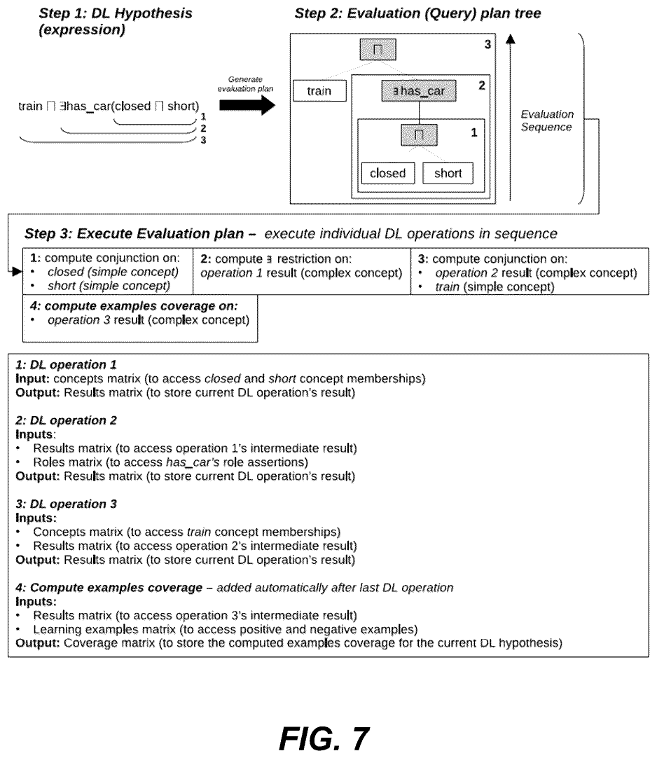

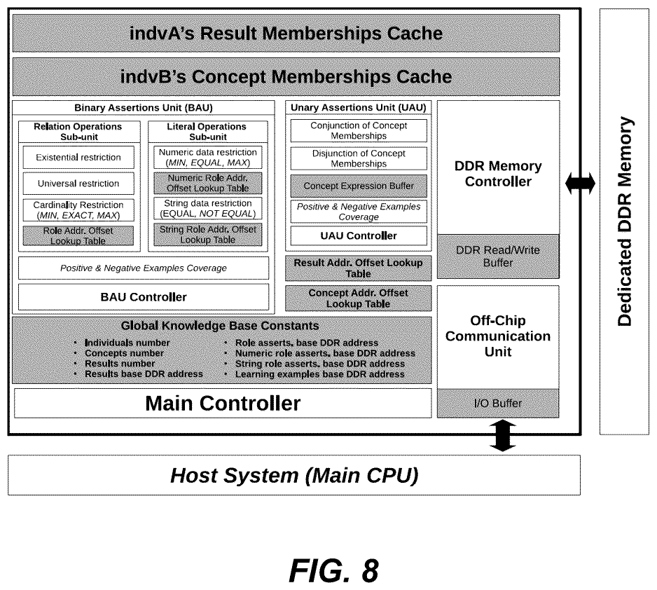

FIG. 7 is a flow diagram showing an example of evaluating a DL hypothesis in HT-HEDL. In terms of evaluating DL hypotheses in HT-HEDL, in order to evaluate the DL hypothesis: train∃has_car (closedsh), the hypothesis has to be broken down into a series of individual DL operations, known as an evaluation plan (see step 2 in the figure). An evaluation plan is a tree data structure that represents the DL hypothesis; the role of an evaluation plan for a DL hypothesis is the same role as using mathematical expression tree to evaluate a given mathematical expression. After the evaluation plan is generated, individual DL operations in the evaluation plan are then executed in sequence, by parsing the plan's tree data structure in a bottom-up manner.

For the train∃has_car (closedshort) hypothesis, executing its evaluation plan results in the following computation steps:

$$( 1 ) closed ⊓ short \to DL\_R1 ( intermediate res )$$

$$( 2 ) ∃ has\_car ( DL\_R1 ) \to DL\_R2 ( intermediate res )$$

$$( 3 ) train ⊓ DL\_R2 \to DL\_R3 ( intermediate res )$$

$$( 4 ) computeExamplesCoverage ( DL\_R3 , LearningExMat ) \to evalResults ( i . e . , covered positives and negatives )$$

Moreover, each DL operation (in the evaluation plan), accesses HT-HEDL's matrix depending on the type of DL operation. For example, for DL operation 1 (closed n sh) the concepts matrix is accessed (to retrieve memberships) and the output is stored in the results matrix; however, for DL operation 3 (trainDL_R2), the concepts matrix is accessed (for train's memberships) and the results matrix is accessed (for DL_R2's memberships). In DL operation 4 (computeExamplesCoverage (DL_R3, LearningExMat)), the results matrix is accessed (for DL_R3's memberships), and the learning examples (LearningExMat) are retrieved from the learning Examples Matrix; the output of DL operation 4 is the covered positives and negatives for the given hypothesis, which is then stored in the Coverage matrix.

Even though the accelerator implements the same matrix-based representation as HT-HEDL; however, with some differences. First, the disclosed accelerator employs a bit-based representation for concept memberships (instead of HT-HEDL's byte-based representation), because bit-based representations (for Boolean data) are more efficient in hardware. Yet, both of the disclosed accelerator and HT-HEDL, employ the same column-major format for concepts membership matrix; That is, all individuals' membership in a given concept, are stored in continuous DDR memory addresses—for efficient memory operations. In the second difference, unlike HT-HEDL, the disclosed accelerator (at least in its current design), only targets speeding up the computations of individual DL operations for hypotheses (as seen in FIG. 5). Therefore, HT-HEDL's Coverage and string CONTAIN matrices are not utilized (as they are not needed); the reason for not utilizing the string CONTAIN matrix is because the current accelerator design does not support the string CONTAIN restriction (yet). The accelerator also does not utilize HT-HEDL's Cardinality counters matrix, because the accelerator follows a different approach for keeping track of matched individual subjects for a given cardinality role restriction.

### Accelerator Components

FIG. 8 is a schematic block diagram showing the accelerator's architecture, showing implementation of HT-HEDL's knowledge representation. The accelerator has on-chip DDR memory controller for accessing the knowledge base, which is stored in the accelerator's dedicated off-chip DDR memory. The blocks in the gray color represent on-chip data storage units (typically implemented using SRAMs); except the “Global Knowledge base constants”, which are typically implemented using registers. Also, one can observe that there is no concepts base DDR address (in the Global Knowledge base constants); because the base DDR address for the concepts matrix is hardcoded to be at zero DDR address—to reduce the need for on-chip data storage. The Global Knowledge base constants contain global registers that provide the base addresses for knowledge base matrices, and also the number of individuals, concepts, and result containers; these global registers are used to calculate DDR addresses for accessing concept memberships, role assertions, and other data from the external DDR memory. The entire accelerator is controlled by the main controller, which manages and coordinates the work of all units of the accelerator. The responsibilities of the main controller also include the handling of incoming processing tasks (received through the off-chip communication unit) from the host system. The off-chip communication unit acts as the interface (or communication) channel between the accelerator and the main (host) system.

In terms of data processing, the accelerator has two data processing units. First is the unary assertions unit (UAU) which is responsible for computing conjunction and disjunction DL operations. In the second data processing unit (i.e., binary assertions unit, or BAU), the unit contains two sub-units (Relation Operations Sub-unit and Literal Operations Sub-unit), which are responsible for computing role and concrete role restrictions, respectively. The BAU unit has two dedicated on-chip cache memories to improve the efficiency of data retrieval (from DDR memory), and these two cache memories are: indvA's Result Memberships Cache and indvB's Concept Memberships Cache.

Both of UAU and BAU units, contain data processing logic for computing examples coverage on the result of their DL operations. The reason for this data processing topology (regarding the accelerator's UAU and BAU units) is because DL operations that have similar data processing pathways (and similar data access patterns), are grouped into a single data processing unit. For example, in the UAU unit, the conjunction and disjunction DL operations access the same data elements in the knowledge base; however, the applied operation on those retrieved data elements is different for conjunction than for disjunction. In the BAU unit, the reason for grouping data processing logic for role and concrete role restrictions in a single processing unit is because both role and concrete role restrictions access binary assertions; therefore, they share some similarities in their data processing pathways. Even though both role and concrete role restrictions access binary assertions, yet, the nature of those binary assertions is different for role and concrete role restrictions. To handle the differences in the nature of those binary assertions, the BAU unit has two sub units: one to handle role restrictions (i.e., Relation Operations Sub-unit), and the other for concrete role restrictions (i.e., Literal Operations Sub-unit).

### Accelerator Data Processing Architecture

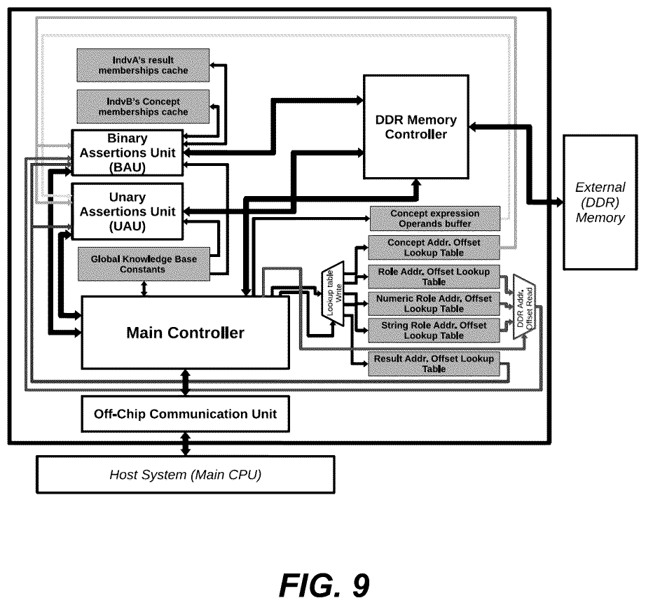

FIG. 9 is a schematic block diagram showing the relation and interface connections between the accelerator's components, describing the data and control connections between the components. The main controller receives the computation commands (through its off-chip communications unit) from the host system. Then, the main controller will decode the received command to determine the type of DL operation to be computed. Once the type of DL operation is determined (e.g., a role restriction), the main controller will use the command's received role ID to retrieve the DDR start address offset (for its corresponding assertions). The retrieved DDR address offset is then passed (through the “DDR Addr. Offset Read” multiplexer) to the BAU unit. After that, the BAU unit is activated by the main controller. Once activated, the BAU unit will add the role assertions' DDR start address offset (from “DDR Addr. Offset Read” multiplexer), with the base address of the roles matrix (retrieved from “Global Knowledge Base Constants”); the result of this DDR addresses addition is the actual DDR memory address that points to the first role assertion (for the given command's role ID). Using the calculated DDR address, the BAU unit will access the role assertions (stored in the off-chip DDR memory), in order to compute the result for the received role restriction command. Once the role restriction results are computed, the BAU unit will either store the computation results in the DDR memory, or directly compute the examples coverage (from the restriction's on-chip result); the examples coverage is computed, only when the received command is for the last DL operation in the given hypothesis.

In terms of concrete role restrictions, they follow an identical path to role restrictions; however, in the BAU unit, the data processing logic for computing concrete role restrictions is different from the data processing logic for computing role restrictions.

In terms of the UAU unit, if the received DL command (from the main controller) is a conjunction or disjunction, then the UAU unit is activated. Similar to the BAU unit, the UAU unit will calculate the actual DDR addresses, by adding DDR start address offsets (from the lookup tables) with the base address of the concepts matrix (which is hardcoded to be 0). The operands for UAU's conjunction/disjunction operations, are stored in the “Concept expression Operands buffer”; the “Concept expression Operands buffer” is populated by the main controller as part of receiving (UAU-related) commands from the off-chip communication unit.

### Unary Assertions Unit (UAU)

As previously stated, the UAU unit is responsible for computing conjunction and disjunction DL operations. The operand in a conjunction/disjunction operation (which is stored in the “Concept expression Operands buffer”) can either be a simple concept (from the concepts matrix) or a complex (result) concept (from the results matrix); a result concept is the result of a previous DL operation (computed from either UAU or BAU units). The UAU unit has an internal controller which is responsible for managing and coordinating all aspects of UAU's internal operations. In other words, the UAU controller is responsible for: receiving, processing, and reporting the results of conjunction and disjunction operations (within the UAU unit).

All of UAU's read/write data from the DDR memory, and are located in sequential memory addresses. Therefore, DDR burst read/write operations are used to retrieve concept memberships and storing the operation result into the DDR memory—which leads into improving the efficiency of DDR memory access (and higher data throughput). Since the UAU unit accesses the DDR memory using burst read/write memory operations, the use of a local (on-chip) cache (in the UAU unit) is not needed—as it may introduce an additional (unnecessary) overhead.

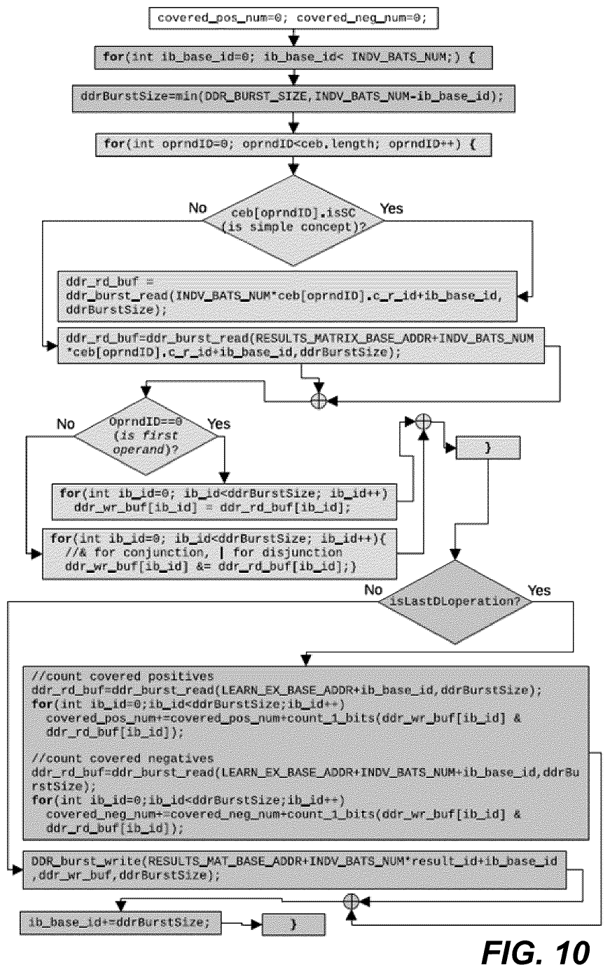

FIG. 10 is a flow diagram showing the workflow for computing conjunction/disjunction operations, using visualized C-like pseudocode. In the flow diagram, ceb refers to the “Concept expression Operands buffer” (described supra in connection with FIGS. 8 and 9), which is an array of operands; where a single operand op consist of two fields: op.c_r_id and op.isSC. The op.c_r_id is the concept or result id for the given operand. op.isSC is a single-bit flag variable that indicate whether the current operand is a simple concept (op.isSC==1) or a result concept (op.isSC==0); for simple operands, the base address 0 is used (for concept matrix); however, for result operands, the base address RESULTS_MATRIX_BASE_ADDR (from “Global Knowledge Base Constants”) is used. The ddr_rd_buf and ddr_wr_buf refer to DDR burst read and write buffers, respectively. The isLastDLoperation flag is a single-bit flag variable that indicates whether the current DL (conjunction/disjunction) operation is the last DL operation in the given hypothesis or not.

The procedure for computing conjunction/disjunction operations (in UAU), consists of two loops: an outer loop (colored in blue, that iterate through all individuals in the knowledge base), and an inner loop (colored in yellow, that iterate through all operands in the given conjunction/disjunction operation). The reason for iterating through all operands (in the inner loop) on the same individuals is because this (conjunction/disjunction) design layout results in less DDR memory access operations; by directing more computations to be performed using data stored in on-chip buffers (instead of DDR memory), before writing their final outputs to DDR memory—as opposed of swapping the inner (operands) loop with the outer (individuals) loop.

The conjunction/disjunction procedure starts by clearing previous values for UAU's covered examples counters (covered_pos_num and covered_neg_num), regardless if the given UAU's operation is the last DL operation (in the DL hypothesis) or not. After that, the individuals loop (i.e., the outer loop) starts. In the individuals loop, individuals are processed in groups known as individual batches, where INDV_BATS_NUM is the number of individual batches in the knowledge base. An individual batch is a group of concept/result memberships, represented by a single memory word; for example, a DDR memory word of 32 bits is a single individuals batch that contain memberships for 32 individuals. In UAU unit, the result of a conjunction/disjunction operation on a single individual batches (of 32 individuals) is computed in parallel (simultaneously). In the inner loop (i.e., the operands loop), the concept membership for a set of individual batches (equal to the DDR memory burst size, e.g., 8 32-bit words) are retrieved through DDR burst read, for each (simple/result) operand; ceb.length refer to the number of operands in the “Concept expression Operands buffer” for the given conjunction/disjunction operation. For simple operands, the concept matrix is accessed for retrieving memberships, while for result operands, the results matrix is accessed. Within the operands loop, if the given operand is the first operand in ceb, then its memberships are simply copied to the output buffer (ddr_wr_b); however, if the given operand is not the first operand, then its retrieved memberships are AND-ed (through and for conjunctions) or OR-ed (I for disjunction) with previous result in output buffer.

After the operands loop completes on the given set of individual batches, the output buffer now has the conjunction/disjunction results for these individuals. Depending on the isLastDLoperation flag, which if isLastDLoperation==1, then the results in output buffer are matched with the positive and negative examples (retrieved from learning examples matrix). The individuals that match the learning examples are counted using covered_pos_num (for positives) and covered_neg_num (for negatives); however, if isLastDLoperation==0, then the results in ddr_wr_buf are stored in the results matrix at result_id (to be used later as an input for next DL operations). It is worth noting that in actual hardware implementation, the data retrieved from DDR memory (through DDR burst reads) are processed as soon as they become available, instead of waiting until the DDR burst read operation is fully completed.

To illustrate the conjunction/disjunction workflow, DL operations 1 and 3 (from FIG. 7) are provided as an example. For DL operation 1 (closed n sh), initially the “concept expression buffer” will contain the operands: [closed's ID, 1] and [short's ID, 1]. Next, concept memberships for closed are retrieved (in a set of individual batches) from concepts matrix (because it is a simple concept). Since the closed concept is the first concept in the “concept expression buffer”, therefore its memberships are simply copied to the output buffer (i.e., ddr_wr_). Similar to the closed concept, memberships for the short concept are retrieved from concepts matrix. Since the short concept is not the first concept in the buffer, its memberships are AND-ed (i.e., a conjunction) with closed's existing memberships in the ddr_wr_buf buffer. After processing all operands (i.e., closed and short concepts), and since isLastDLoperation=0, conjunction results in ddr_wr_buf (for a set of individual batches) are then written to the results matrix as an intermediate result; to be used as an input for DL operation 2 (i.e., ∃ restriction on DL operation 1's result). The process of computing closed n sh, repeats for a different set of individual batches each time, until all individuals in the knowledge base are processed.

For DL operation 3 (train n ∃has_car (closed n sh)), the “concept expression buffer” will contain: [train's ID, 1] and [DL_OP2's ID, 0]. The train concept is processed similar to closed concept in DL operation 1, because it is a simple concept and because it is the first operand in the buffer; however, for DL_OP2 which is the intermediate result of DL operation 2 (∃has_car (closed n sh)); the memberships for DL_OP2, are retrieved from the results matrix, because it is a complex concept. Once DL_OP2's memberships are retrieved, they are processed in the conjunction similar to simple concepts. Since DL operation 3 is the last DL operation in the given hypothesis (i.e., isLastDLoperation=1), the results in ddr_wr_buf are used to compute the covered positive and negative examples (for the given hypothesis).

It is worth noting that, in FPGA-based implementation, the performance for counting covered examples (in FIG. 10) can be optimized through pipelining to increase: the design's maximum operating clock, and the computing throughput.

### Binary Assertions Unit (BAU)

As mentioned supra, the Binary Assertions Unit (BAU) unit is responsible for DL operation on binary assertions; that is, restrictions on role and concrete roles. The BAU unit uses its “Relationship Operations sub-unit” to compute role restrictions, and “Literal Operations sub-unit” to compute concrete (numeric and string) role restrictions. The supported role and concrete role restrictions by the BAU unit are:
Existential role restriction.
Universal (value) role restriction.
Cardinality (MIN, EXACT, and MAX) role restriction.
Numeric (MIN, EQUAL, and MAX) concrete role restriction.
String (EQUAL and NOT EQUAL) concrete role restriction.

To improve the computing performance of DL operations (in the BAU unit), the BAU unit employs two on-chip caches: indvA's Result Memberships Cache and indvB's Concept Memberships Cache; where indvAs are the subject individuals in role (and concrete role) assertions, and indvBs are the object individuals in role assertions. The indvA's Result Memberships Cache is used to cache the output (for all of BAU's DL operations), before finally writing them into the results matrix (i.e., in the off-chip DDR memory). In the indvB's Concept Memberships Cache, the BAU unit retrieves concept memberships for all object individuals on the given role restriction's concept, from DDR memory into the indvB on-chip cache—for fast retrieval of indvBs' concept memberships, by the processing logic of BAU's role restrictions.

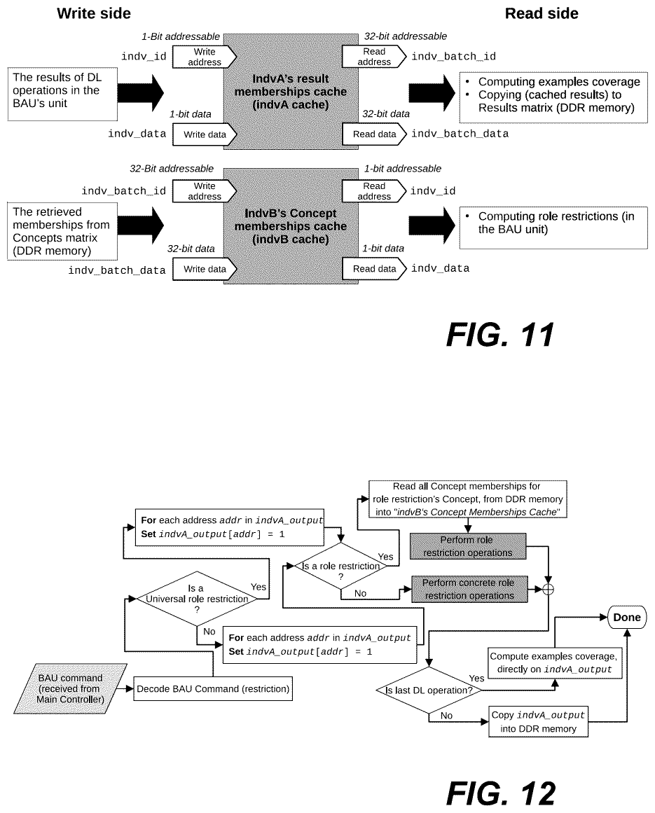

FIG. 11 is a schematic block diagram showing the memory architecture for indvA and indvB caches (assuming DDR words are 32-bits). The difference between the accelerator's two caches is that the indvB's Concept Memberships Cache is only used for role restrictions, whereas the indvA's Result Memberships Cache is used for all of BAU's DL restrictions (i.e., for both of role and concrete role restrictions). The reason for using two on-chip caches is because all DL operations in the BAU unit, heavily engage in random memory access patterns to either: write data to results matrix, or to read data from concepts matrix (in case of role restrictions). These heavily used random memory access patterns (by all DL operations in the BAU unit), are more efficient in an on-chip SRAM cache memory (than on an off-chip DDR memory). The memory architecture for both cache memories is represented in FIG. 11, in which one can observe that on each cache memory, the read and write ports are of different (data and address) widths. The usage of the two caches depends on the given DL restriction. For role restrictions, the concept memberships for all individuals are retrieved (in individual batches) using burst read operations from DDR memory, into the indvB cache. After that, the role restrictions (in BAU) will then use the cached concept memberships, and the retrieved role assertions (from Roles matrix, i.e., from DDR memory); to compute role restriction results, which are then written for one individual at a time in the indvA cache—per parsed role assertion. In terms of the indvA cache, all DL operations in BAU write their output to the indvA cache. The stored results in the indvA cache, are then used to either: compute examples coverage, or to be used as an input for other DL operations—by copying the results from indvA cache to the results matrix (using DDR burst write operations).

FIG. 12 is a flow diagram showing the workflow for the BAU unit. In the diagram, indvA_output refers to “indvA's Result Memberships Cache”. Before computing any role or concrete role restriction, a “cache preparation” procedure is performed on the indvA cache, and the procedure is different depending on the restriction type. If the restriction type is a universal role restriction, the indvA cache is set to all 1s; otherwise (i.e., any other role or concrete role restriction), the indvA cache is cleared to all 0s. The cache preparation procedure (on the indvA cache) is a preprocessing step which is always performed before computing any of BAU's restrictions.

Once the cache preparation procedure is complete, the next step is computing the result for the restriction; where role restriction computations are directed to the Relationship Operations Sub-unit, and concrete (numeric/string) role restriction computations are directed to the Literal Operations Sub-Unit.

Similar to the UAU unit, in the BAU unit, if the completed restriction is the last DL operation in the given hypothesis, the computations for examples coverage are performed directly on the indvA cache; the procedure for computing examples coverage in the BAU unit is described in Algorithm 1:

Algorithm 1: A Verilog-like pseudocode
for computing coverage in the BAU unit

| | |
|---|---|
| 1 | BAU_COMPUTE_COVERAGE: begin |
| 2 | ... |
| 3 | // countpositives |
| 4 | covered_pos_num <= covered_pos_num + |
| 5 | count_1_bits (indvA_output [indv_batch_ind] |
| | & pos_indvs_bat) ; |
| 6 | |
| 7 | // countnegatives |
| 8 | covered_neg_num <= covered_neg_num + |
| 9 | count_1_bits (indvA_output [indv_batch_ind] |
| | & neg_indvs_bat) ; |
| 10 | |
| 11 | if (& indv_batch_ind) // lastreadaddress |
| 12 | bau_state <= BAU_DONE ; |
| 13 | else begin |
| 14 | bau_state <= BAU_COMPUTE_COVERAGE |
| 15 | indv_batch_ind <= indv_batch_ind + 1 ; |
| 16 | end // if (& indv_batch_ind) |
| 17 | end // BAU_COMPUTE_COVERAGE |

In Algorithm 1, the covered (positive and negative) examples by any of BAU's DL restrictions, are computed in BAU's BAU_COMPUTE_COVERAGE state (i.e., when bau_state==BAU_COMPUTE_COVERAGE).

In the BAU_COMPUTE_COVERAGE state, indv_batch_ind refers to the read address that retrieves individual batches from indvA_o. pos_indvs_bat and neg_indvs_bat refers to the retrieved positive and negative examples for the given indv_batch_ind. For each read address in indvA_o, the corresponding learning examples are retrieved and then used to compute the examples coverage (for their individual batches). Similar to UAU's procedure for computing examples coverage (in FIG. 10), the performance for Algorithm 1 can be optimized through pipelining.

If the current BAU's restriction is not the last DL operation, then the contents of indvA's cache are copied into the results matrix, to be used as an input for next DL operations in the given hypothesis.

### Relationship Operations Sub-Unit

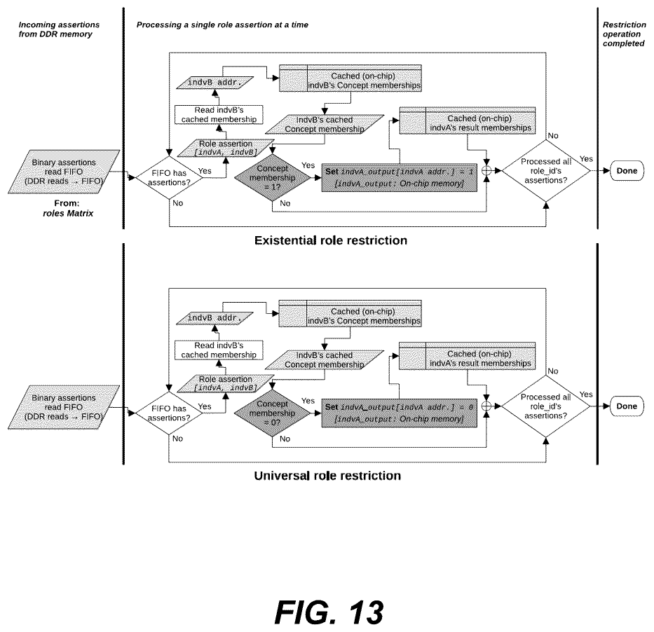

FIG. 13 is a flow diagram showing the workflow for computing existential and universal role restrictions. As mentioned supra, this BAU's sub-unit is responsible for computing role restrictions; that is: existential, universal, and cardinality role restrictions. It can be seen that role assertions are continuously being retrieved from DDR memory into an on-chip FIFO—in a streaming manner. Both existential and universal restrictions share similar workflow; however, the differences between the two restrictions are marked in blue. In existential restrictions, role assertions are checked, to find at least one role assertion for a given subject (indvA), where its corresponding object (indvB) has a membership in the restriction's concept. If a role assertion was found for indvA where its indvB satisfies the (existential restriction) condition, then the result for this indvA is set to 1 (i.e., a match was found). For universal restrictions, similar process is followed as existential restrictions; however, in universal restrictions, if there is a role assertion for a given indvA was found, where its indvB has no membership in the restriction's concept; then, set the result for the given indvA to 0 (i.e., a no match was found). The essence of the universal restriction dictates that all role assertions for a given indvA must have their indvBs, be members in the universal restriction's concept. In other words, the universal restriction initially assumes that all indvAs are matched (based on BAU's initialization of the indvA cache to all Is, in FIG. 12); therefore, the universal restriction looks for any role assertion, for a given indvA where its indvB is not a member in the (universal) restriction's concept.

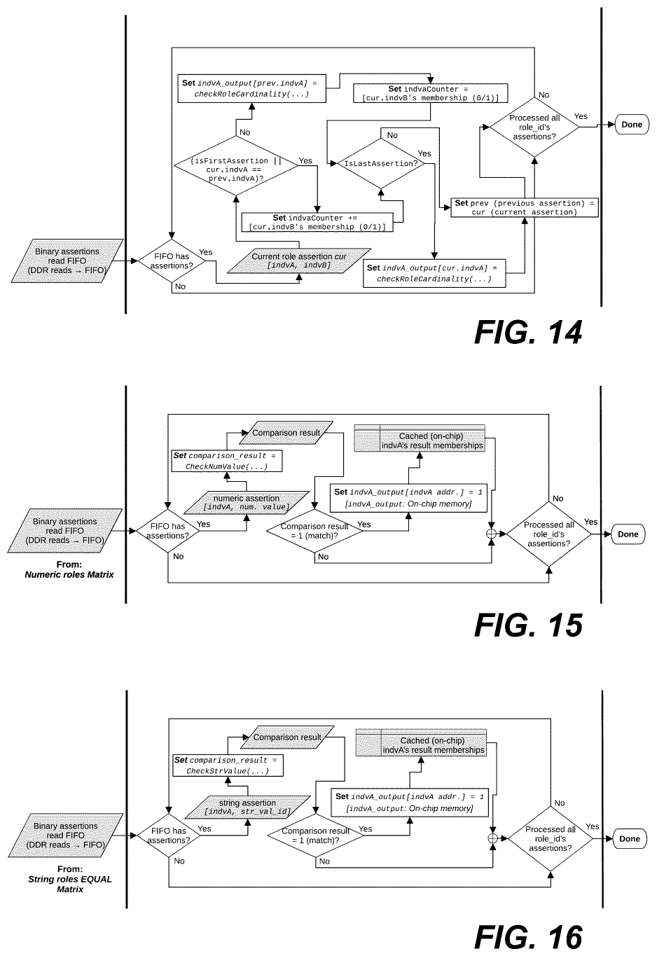

FIG. 14 is a flow diagram showing the workflow for computing cardinality role restrictions. In terms of cardinality restrictions, all role assertions (in the roles matrix) are assumed to be sorted by their indvAs; that is, all role assertions for the same indvA (on a given role), are grouped together (in sequential memory addresses). For each incoming role assertion (from DDR memory), if indvA for the current role assertion is the same as the indvA in the previous role assertion; then increment indvACounter based on the current assertion's indvB concept membership. In other words, the number of matched indvBs for a particular indvA is counted, until a different indvA is encountered in upcoming assertions. If the retrieved upcoming assertion has a different indvA (than previous assertion), then the values for: cardinality type (MIN/EQUAL/MAX), cardinality compare value, and indvACount; are passed to the checkRoleCardinality( . . . ) function, described in Algorithm 2:

Algorithm 2: A Verilog-like pseudocode
for checkRoleCardin(...) function

| | |
|---|---|
| 1 | function check RoleCardinality (ct_ms , |
| | cardinalityType , cmp_value) ; |
| 2 | begin |
| 3 | case (cardinalityType) |
| 4 | MIN_CARDINALITY : return (ct_ms >=cmp_value) ; |
| 5 | EXACT_CARDINALITY : return (ct_ms==cmp_value) ; |
| 6 | MAX_CARDINALITY : return (ct_ms >0 && |
| | ct_ms <=cmp_value) ; |
| 7 | default: return 0 ; |
| 8 | endcase |
| 9 | end |
| 10 | endfunction |

In Algorithm 2, ct_ms refers to the number of matched memberships for a given indvA (i.e., indvACoun), and cardinalityType is the cardinality type; cmp_value is the cardinality compare value. The checkRoleCardin( . . . ) function is used to check whether the indvA (of previous assertion) and its corresponding indvACounter value, matches the cardinality restriction condition. The result of the checkRoleCardin( . . . ) function is then stored at the (previous) indvA address in the indvA cache. After computing the cardinality restriction result for the previous indvA, the value of indvACounter is then set to equal indvB's concept membership from the newly retrieved assertion (with the different indvA).

The performance of BAU's role restrictions (in FPGA-based implementations), can be optimized by performing the cache preparation procedure (for indvA cache) in parallel, with the retrieval of concept memberships (from DDR memory) into the indvB cache.

### Literal Operations Sub-Unit

FIG. 15 is a flow diagram showing the workflow for computing numeric restrictions. In the Literal operations sub-unit, the procedure for computing numeric and string concrete role restrictions is similar to that of existential role restriction; by which, the restriction scans all assertions to find at least one an assertion, that matches specific conditions. Similar to Relationship Operations Sub-unit, the assertions in the Literal Operations Sub-Unit are retrieved (DDR memory) into a local FIFO—in streaming manner.

The retrieved assertions are in the form (indvA, num_value) where indvA is the assertion's subject (similar to role assertions), and num_value is the assertion's numeric value; the type of numeric value can be: integer, fixed-point, float, etc. For each incoming numeric assertion, pass its num_value value to the checkNumValue ( . . . ) function in Algorithm 3; to check whether the assertion's value matches the numeric restriction condition (or not). In Algorithm 3, a_nval refers to the assertion's (numeric) value, restrictType for numeric restriction type, and cmp_num_val for numeric restriction compare value. The result of the checkNumValue ( . . . ) function for the assertion's indvA is then stored into the indvA cache (at indvA's address). It is worth noting that, if numeric restrictions are to be implemented using FPGAs, that doesn't have dedicated hardware for handling float numbers (such as an FPU, or float point unit); fixed-point numbers can be used to represent float numbers, where the FPGAs integer hardware can be utilized for arithmetic and comparison operations.

Algorithm 3: A Verilog-like pseudocode
for checkNumValue (...) function

| | |
|---|---|
| 1 | function checkNumValue (a_nval , restrictType , cmp_num_val) ; |
| 2 | begin |
| 3 | case (restrictType) |
| 4 | NUMERIC_MIN: return (a_nval >= cmp_num_val) ; |
| 5 | NUMERIC_EQUAL : return (a_nval == cmp_num_val) ; |
| 6 | NUMERIC_MAX: return (a_nval <= cmp_num_val) ; |
| 7 | default: return 0 ; |
| 8 | endcase |
| 9 | end |
| 10 | endfunction |

FIG. 16 is a flow diagram showing the workflow for computing string restrictions. In terms of string restrictions, they follow a similar workflow as numeric restrictions; however, they operate on string (concrete role) assertions. The assertions are retrieved from DDR memory (similar to other role and concrete role restrictions). The retrieved assertions are in the form (indvA, str_val_id), where indvA is the subject and str_val_id is a numeric (integer) mapping of the assertion's string value; the mappings of string values to numeric values, are stored in the String values mapping table. On each retrieved string assertion, the checkStrValue ( . . . ) function (in Algorithm 4) is used on str_val_id, to compute the restriction's result for the individual indvA. In Algorithm 4, a_sval_ind refers to the assertion's numeric mapping (to its string value), restrictType is the restriction type (EQUAL/NOT EQUAL), and cmp_str_val_ind is the restriction's compare value.

It is worth noting, that the hardware-based accelerator (described in this article), proposes reengineered variations of HT-HEDL's algorithms; to improve the performance of DL operations—using hardware-based acceleration approaches.

Algorithm 4: A Verilog-like pseudocode
for checkStrValue (...) function

| | |
|---|---|
| 1 | function checkStrValue (a_sval_ind , |
| | restrictType , cmp_str_val_ind) ; |
| 2 | begin |
| 3 | if (restrictType == STRING_EQUAL) |
| 4 | return (a_sval_ind == cmp_str_val_ind) ; |
| 5 | else |
| 6 | return (a_sval_ind != cmp_str_val_ind) ; |
| 7 | end |
| 8 | endfunction |

### Implementation

Implementation of the disclosed technology is accomplished with the setup and the methodology for evaluating the disclosed accelerator using experimental results. The disclosed technique is implemented using the Verilog language, on the Cyclone V GX Starter board, which has the Cyclone V GX (5CGXFC5C6F27C7N) FPGA. The implemented FPGA design is running on a 125 MHz clock. Details regarding the FPGA implementation and its resource utilization can be seen in Table 4:

TABLE 4
FPGA implementation details for the disclosed technique.
Cyclone V GX Starter board's resource utilization

| | | | |
|---|---|---|---|
| FPGA chip | Adaptive logic modules (ALMs) | 4,866/29,080 | (17%) |
| | On-chip memory bits | 2,282,816/4,567,040 | (50%) |
| | On-chip hardware memory controllers | 1/2 | (50%) |
| | Digital signal processing (DSP) Blocks | 4/150 | (3%) |

| | | |
|---|---|---|
| FPGA Board | LPDDR2 memory | 500 MB (32- |
| | | bit data words) |
| | Host-FPGA communication | UART |
| | | (through USB) |

In Table 4, one can observe that the disclosed technique consumes fewer data processing units (ALMs and DSP blocks) of the given FPGA's resources, to implement the data processing logic for the design; however, the implementation consumes very large amount of FPGA's on-chip memory to provide storage needs for: indvA and indvB caches (implemented as Dual-Port RAM), concept expression operands buffer (implemented as a Single-Port RAM), and the memory address offset (id→DDR address offs) lookup tables (such as the “Concept Addr. Offset Lookup Table”, in FIG. 9). All (memory address offset) lookup tables are implemented as Single-Port RAM.

The remaining of the on-chip memory is used for other needed data buffers, such as UART receive/transmit buffers, DDR read/write buffers, etc. Most of the FPGA's on-chip memory is consumed by indvA's and indvB's membership caches, by which, both caches consumes a total of 2,097,152 (2×1,048, 576) bits—which is 46% of the FPGA's on-chip memory. Since each of indvA and indvB caches are 1,048,576 bits each, a single indvA or indvB cache can store concept memberships for up to 1,048,576 different (unique) individuals; this upper limit (for the maximum number of unique individuals) is imposed by the FPGA's on-chip memory capacity. In other words, FPGAs with more on-chip memory capacities, will have bigger indvA and indvB caches, which consequently lead into storing concept memberships for more number of unique individuals.

The disclosed technique rely heavily on the FPGA's on-chip memory for caching indvA and indvB concept memberships; because to compute role restrictions (in the BAU unit), indvA and indvB concept memberships are frequently retrieved (in a random access pattern)—and caching those frequently accessed data locally (especially in a very fast on-chip memory), will improve performance.

The performance of the disclosed technique is evaluated by providing experimental results for all supported operations by both the UAU and BAU units. For all supported operation, experimental results are included for both cases of isLastOps==1 (is last DL operation, compute examples coverage), and isLastOps==0 (is not last DL operation, store computation results into the DDR memory). A synthetic (computer generated) dataset is used for all experimental results. The synthetic dataset consist of:
#Individuals: 100 million.
#Concepts: 32.
#Learning examples: 100 million positive+100 million negative.
#Roles: 1.
#Role assertions: 1 million.
#Numeric concrete roles: 1.
#Numeric (float) assertions: 1 million.
#String concrete roles: 1.
#String assertions: 1 million.

To establish the baseline for the experiments, a sequential version of the design's operations is implemented using the C/C++ language. Then, this baseline software implementation is executed by the Raspberry Pi 4 board. The Raspberry Pi board was chosen for baseline experiments, because it is a well-known single-board computer in the field of embedded systems. To ensure a consistent CPU performance for the raspberry PI, its CPU clock is locked at 1.5 GHz (the stock clock).

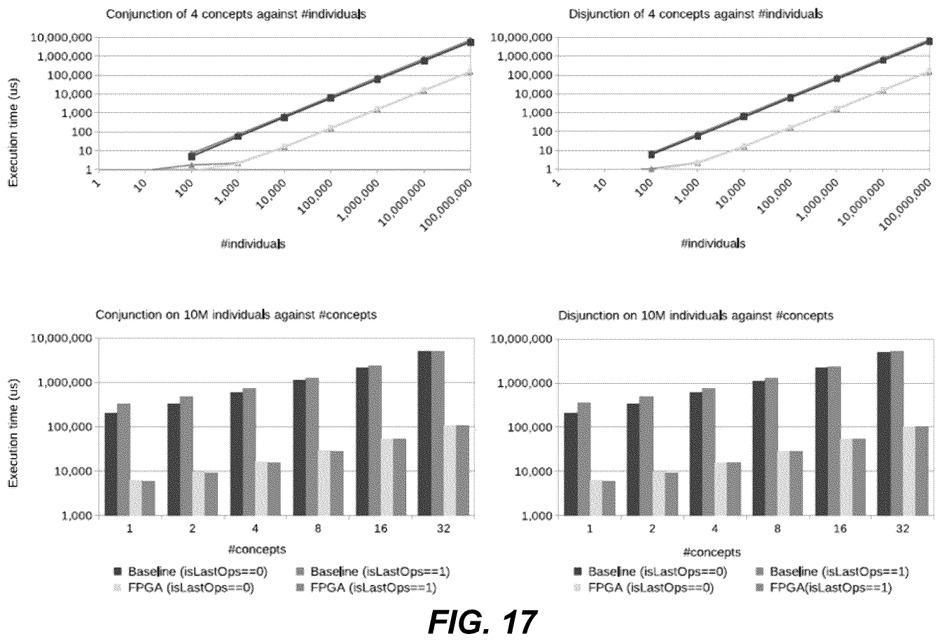

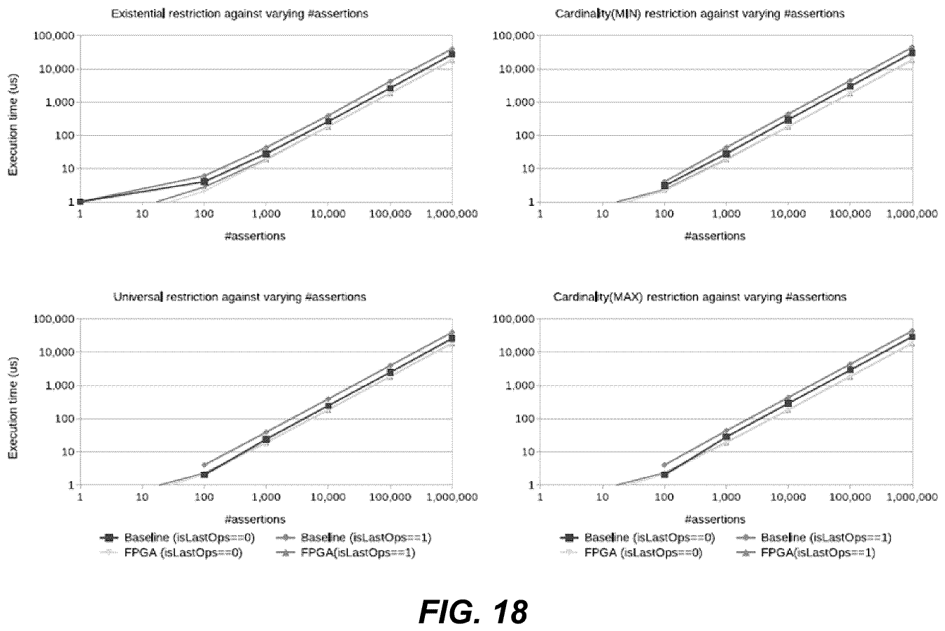

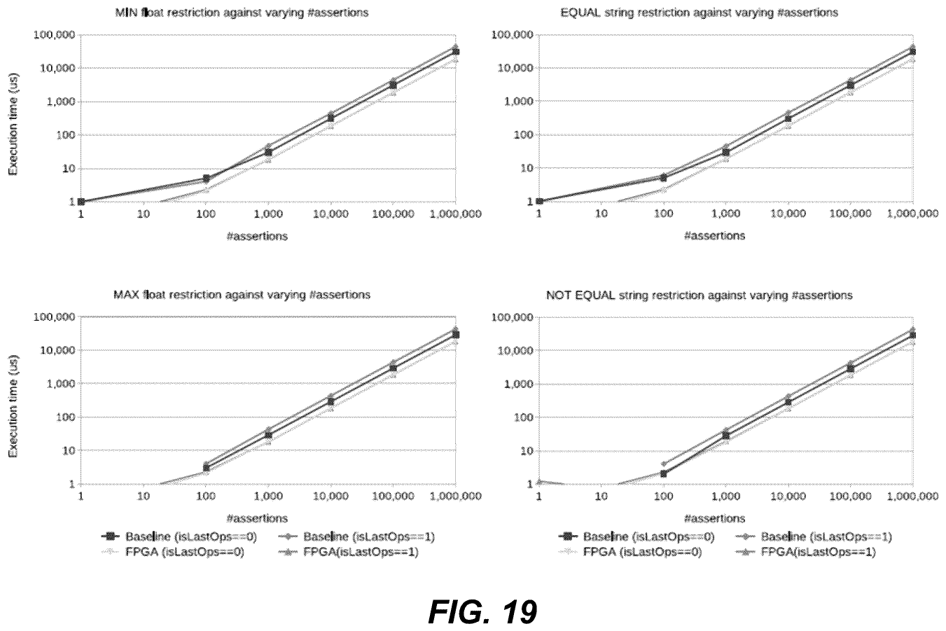

For the UAU unit, the experimental results for the conjunction and disjunction operations are reported in FIG. 17. For the BAU unit, the experimental results for relational (role) restrictions are reported in FIG. 18. For BAU's literal (concrete role) restrictions, the experimental results for numeric and string restrictions are reported in FIG. 19. For all BAU experiments, the number of assertions is limited to 1M; that is, the maximum number of unique individuals, that can be represented by the implemented indvA and indvB caches using the FPGA's on-chip (SRAM) memory. All reported experimental results are in microseconds. In FIG. 18, report experimental results are reported for MIN and MAX cardinality restrictions only; experimental results for the EXACT cardinality restriction are not included because it has an identical complexity as the MIN cardinality restriction (see Algorithm 2). Therefore, the experimental results for the MIN cardinality restriction, also serves as the representation for the EXACT cardinality restriction. For literal numeric restrictions, all of the restriction's variations (MIN/EQUAL/MAX) have and identical complexity (see Algorithm 3). Therefore, two variations (MIN/MAX) are included as representative of the restriction's performance.

FIG. 17 is a graphical presentation showing a visualization of experimental results on conjunction and disjunction operations.

FIG. 18 is a graphical presentation showing a visualization of experimental results on existential, universal, and cardinality (MIN and MAX) role restrictions.

FIG. 19 is a graphical presentation showing a visualization of experimental results on numeric (MIN and MAX) and string (EQUAL and NOT EQUAL) restrictions.

### PERFORMANCE

According to the experimental results (in FIG. 17-19), one can observe that the FPGA implementation of the accelerator has improved performance; despite the FPGA having a much lower clock (of 125 MHz) as opposed to the Raspberry Pi's 1.5 GHz CPU clock (which is 12 times faster than the accelerator's clock). For UAU's DL operations, the FPGA implementation improved performance by up to ~48.7-fold (on a disjunction of 32 concepts on 100M individuals, isLastOps==1). Moreover, on a conjunction of a single concept against 10 Million individuals, the accelerator achieved a speed increase of 32-fold (when isLastOps==0) and ~55-fold (when isLastOps==1); similar performance was achieved by the accelerator on a disjunction operation (of a single concept against 10 Million individuals). At 10 million individuals, the accelerator achieves consistent speed increases of at least 32-fold regardless of #concept values on both conjunction and disjunction operations. Increasing #concept for a given conjunction/disjunction operation, will result in higher speed increases. For example, at 10 million individuals (and at isLastOps==0), a conjunction operation of 2 concepts will result in a speed increase of ~34-fold; whereas the same conjunction though with 4 concepts, will result in speed increase of ~36-fold. The UAU unit provides higher speed increases when isLastOps==1 (as opposed to isLastOps==0), because on isLastOps==1, the UAU unit counts the covered examples directly from the intermediate results stored in the on-chip memory; on the other hand (i.e., isLastOps==0), the UAU unit will write the intermediate results to DDR memory, which has higher overhead than the on-chip memory—which consequently reduce the speed increases achieved by the accelerator. Regardless of isLastOps value, the FPGA provides consistent speed increases for UAU's conjunction and disjunction operations, when the number of individuals is ≥100 (as seen on FIG. 17).

For BAU's DL operations, the performance gains starts to appear at ≥100,000 assertions, and starts to grow larger (in favor of the FPGA) on higher assertions number; as seen on FIG. 18 for role restrictions, and FIG. 19 for concrete role restrictions. At ≥100,000 assertions, on an existential restriction on 1M role assertions, the FPGA accelerator has achieved a performance increase of ~33% (isLastOps==0) and ~53.3% (isLastOps==1); similar performance gains were achieved for the universal restriction (on 1M role assertions); however, cardinality role restrictions has achieved the most performance gains (in comparison to the aforementioned role restrictions); on the same 1M role assertions, a MIN cardinality restriction has achieved a performance increase of ~39% (isLastOps==0) and ~59% (isLastOps==1). Cardinality restrictions involve more computations steps (as opposed to other role restrictions). In the CPU-based cardinality restriction implementation, these additional computation steps are processed sequentially—that is, the traditional (scalar) approach. On the other hand, the FPGA accelerator completes the same computation steps using fewer clock cycles, with also some steps are completed in parallel within the same FPGA clock cycle. As a result, the accelerator will achieve higher performance gains for cardinality restrictions (over other role restrictions), because more sequential computation steps are being completed in parallel by the FPGA, using also fewer clock cycles.

In terms of concrete role restrictions, the accelerator has achieved higher performance gains in comparison to existential and universal role restrictions. On 1M float assertions, a MIN float concrete role restriction using the accelerator, has achieved a performance increase of 40.2% (isLastOps==0) and ~58% (isLastOps==1); similar performance gains were achieved for String concrete role restrictions. The reason for why the BAU unit achieved higher speed increases on isLastOps==1 (over isLastOps==0) on both role and concrete role restrictions is because at isLastOps==1, the BAU unit compute covered examples for a group of 32 individuals at a time, in parallel; whereas in the CPU-based implementation, the CPU compute the covered examples, one individual at a time—as a result, the BAU unit has a higher performance advantage (despite its lower clock speed) due to higher level of parallelism.

In terms of isLastOps's effect on performance, it was observed that isLastOps (isLastOps==0 or isLastOps==1) has a slight impact on FPGA performance—on all DL operations of UAU and BAU unit. In other words, the FPGA performance for all DL operations (in UAU and BAU) at isLastOps==1 is very close to the FPGA performance at isLastOps 0 (given the same DL operation)—even though at isLastOps==1, more computations are performed to compute the examples coverage, in addition to the computations of the DL operation. On the other hand, the performance impact of isLastOps on DL operation computations using baseline (i.e., sequential CPU implementation) is different depending on the DL operation. For UAU operations, the baseline performance is affected by isLastOps—especially at ≥1,000, 000 individuals. Furthermore, for BAU operations, the baseline performance is negatively affected by isLastOps==1 (as opposed for isLastOps==0)—especially at ≥100,000 assertions, where the baseline performance gap (between isLastOps 1 and isLastOps==0) grows larger. The performance characteristics for the accelerator's FPGA implementation can be described using best case and worst case scenarios. In the best case scenario, the FPGA implementation is always faster (than baseline) at ≥100 individuals for UAU operations. For BAU operations, the FPGA is always faster at ≥100,000 assertions; however, in the worst case scenario, the FPGA implementation (for all DL operations of UAU and BAU units) will provide similar (if not identical) performance to the baseline. In other words, in order to achieve performance speed increases through the FPGA, the data has to be large enough.

The experimental results for evaluating the disclosed hardware-based accelerator (using an FPGA implementation), clearly provide the evidence that hardware-based approaches do in fact accelerate performance for ILP-related computations—in particular, hypothesis evaluation computations.

In terms of the accelerator's implementation challenges, the accelerator require large amount of on-chip memory to cache memberships (indvA's Result Memberships Cache and indvB's Concept Memberships Cache), which also limit the number of unique individuals that the accelerator's BAU unit can process (for role and concrete role restrictions) in a given DL knowledge base. In addition, The reason for UAU's high speed increases (48.7-fold faster than baseline) is because DL operations in UAU, are taking advantage of the FPGA's parallel computing capabilities. On the other hand, for BAU's DL operations, a design (and an implementation) limitation exist where more computations are performed sequentially rather than in parallel (on the FPGA); consequently, leading to relatively lower (or poor) speed increases when compared to UAU's speed increases—because FPGAs typically have poor sequential performance due to lower clock speeds (as opposed to modern CPUs, that typically have clocks in the GHz range).

Given the fact that an FPGA implementation of the accelerator's design running on a clock 12 times slower than baseline's (1.5 GHz) clock, has indeed provided speed increases (up to ~48.7-fold in best case scenario); even though the current accelerator design is disclosed as a general hardware architecture, that doesn't specifically targets FPGA-based implementation—this clearly suggest that optimizing the disclosed accelerator's design for targeting FPGA-based implementations, will have the potential for achieving more FPGA-based performance for ILP computations; however, the accelerator in its current design (especially for the performance of its BAU unit) is not expected to compete with the performance improvements introduced by CPU multithreading and GPU-based approaches. The main goal of the accelerator's current design is to study the efficacy of using hardware approaches to accelerate ILP computations; and also to act as an alternative performance improvement approach among other existing (CPU and GPU based) approaches.

### Results

According to the present disclosure, a hardware-based (accelerator) design is implemented to provide hardware-based acceleration approaches, at improving the performance for ILP-related computations using Description Logic (DL). In particular, the technique focused on improving the performance of hypothesis evaluation, for DL-based ILPs that uses the ALCQ(D) DL language. For improving the performance of hypothesis evaluation, the disclosed hardware-based accelerator accelerates the computations of: individual DL operations, and examples coverage. For improving individual DL operations, the disclosed accelerator improves the performance for: conjunction, disjunction, (existential/universal/concrete) role restrictions, and concrete (float/string) role restrictions. For improving examples coverage, the disclosed accelerator improves the performance by computing in parallel the number of covered positives and negatives for multiple individuals—at the same time.

For evaluating the disclosed accelerator, experimental results obtained using an FPGA implementation of the accelerator design. The experimental results provided clear evidence that, using hardware-based acceleration approaches, the configuration will indeed introduce performance improvements for ILP-related computations—especially for DL-based ILPs. To quantitatively evaluate the performance improvements (introduced by the disclosed accelerator, and its given FPGA implementation), speed increases of up to 48.7-fold were achieved (for a disjunction operation) in the best case scenario. In the worst case scenario, the FPGA implementation provided either a similar or slightly better performance than the baseline (i.e., sequential CPU implementation), when the data is too small; that is, when the number of individuals is <100 (for conjunction and disjunction), and when the number of assertions is <100,000 (for role and concrete role restrictions). Even though the given FPGA implementation of the disclosed accelerator is running at 12 times slower clock than a CPU with 1500 MHz clock, yet the FPGA implementation still provides significant speed increases—especially in its best case scenario. In other words, implementing the accelerator design on a more powerful hardware with a higher clock (and more on-chip memory capacity), will indeed result in more speed increases being achieved; however, for FPGA-based implementations, using higher clock speeds will introduce more implementation challenges such as meeting the FPGA's hardware constraints—especially timing and clock related constraints.

The current accelerator design is disclosed as a general hardware-based design that doesn't target (or is not optimized for) a particular hardware implementation (e.g., FPGA), as a potential future refinement. Since the disclosed current accelerator design is a general hardware-based design, an optimized version of the accelerator design could be implemented which is optimized for FPGA-based implementations. For other implementations, more DL operations could be supported to increase the expressivity of the used DL language.

### CLOSING STATEMENT

It will be understood that many additional changes in the details, techniques, steps and specific programs, which have been herein described and illustrated to explain the nature of the subject matter, may be made by those skilled in the art within the principle and scope of the invention as expressed in the appended claims.

1. A method for provide hardware-based acceleration of computer operations, the method comprising:
providing a plurality of Description Logic (DL) language inductive logic programming (ILP) instructions for performing a hypothesis evaluation task, at least a subset of said instructions expressed as logic-based rules or textual-like descriptions, in a form capable of interpretation by both humans and machines;
using a circuit for selecting a knowledge base interpretable by ILP to select a knowledge base interpretable by Inductive Logic Programming;
selecting a set of concept axioms that enforces a set of logic-based constraints on the knowledge base, wherein the logic-based constraints establish reasoning tasks on the knowledge base using the ILP;
using a hardware configuration to implement the established reasoning tasks through a hardware implementation;
applying the knowledge base and the set of concept axioms to perform the hypothesis evaluation task by performing a hypothesis search, the hypothesis search comprising scanning each assertion to find at least one assertion, that matches specific conditions, and selecting one or more hypotheses as DL hypotheses; and
evaluating at least one of the DL hypothesis obtained by executing the hypothesis evaluation task through the hardware implementation, and for each DL hypothesis, using the computed examples coverage to compute an evaluation score for the given hypothesis,
wherein the execution of the hypothesis evaluation task provides hardware-based acceleration that accelerates hypothesis evaluation computations for the DL-based ILP learners used in the computer operations.

2. (canceled)

3. The method as described in claim 1, further comprising:
representing outputs of DL operations as the reasoning tasks for a given DL hypothesis as a logical matrix.

4. The method as described in claim 1, further comprising:
representing outputs of DL operations as the reasoning tasks for a given DL hypothesis as a logical matrix, so that each matrix represents an aspect of the DL knowledge base,
wherein a results matrix represents the outputs of DL operations for a given DL hypothesis,
wherein the DL accesses a concepts matrix,
and wherein a results matrix provides an output storage configuration.

5. The method as described in claim 1, further comprising:
representing the DL operations as the reasoning tasks for a given DL hypothesis as a logical matrix, wherein each matrix represents an aspect of the DL knowledge base, with a results matrix representing the outputs of DL operations for a given DL hypothesis; and
providing a results matrix as an output.

6. The method as described in claim 1, further comprising:
performing the DL operations while retrieving input data; and
initiating processing of the retrieved data as the retrieve data becomes available without waiting until completion of a burst read operation.

7. The method as described in claim 1, wherein using the hardware configuration to implement the established reasoning tasks provides an acceleration function to accelerate performance for ILP-related computations.

8. The method as described in claim 1, wherein using the hardware configuration to implement the established reasoning tasks provides an acceleration function to accelerate performance for ILP-related computations comprising hypothesis evaluation computations.

9. A hardware-based accelerator configured to perform the method of claim 1.

10. A hardware-based accelerator comprising:
a circuit for providing a plurality of Description Logic (DL) language inductive logic programming (ILP) instructions for performing a hypothesis evaluation task, at least a subset of said instructions expressed as logic-based rules or a textual-like descriptions, in a form capable of interpretation by both humans and machines, in a form capable of interpretation by both humans and machines;
a circuit for selecting a knowledge base interpretable by Inductive Logic Programming (ILP);
a circuit for implementing a set of concept axioms that enforces a set of logic-based constraints on the knowledge base, wherein the logic-based constraints establish reasoning tasks on the knowledge base using the ILP, described with general terms and at least one assertion;
a hardware circuit implementing the established reasoning tasks;
a circuit for applying the knowledge base and the set of concept axioms to perform the hypothesis evaluation task by performing a hypothesis search, the hypothesis search comprising scanning each assertion to find at least one assertion, that matches specific conditions; and
a circuit for evaluating at least one of the DL hypothesis obtained by executing the hypothesis evaluation task through the hardware implementation, and for each DL hypothesis, using the computed examples coverage to compute an evaluation score for the given hypothesis,
wherein the circuit for execution of the hypothesis evaluation task provides hardware-based acceleration that accelerates hypothesis evaluation computations for the DL-based ILP learners used in the computer operations.

11. (canceled)

12. The hardware-based accelerator as described in claim 10, further comprising:
a circuit for representing outputs of DL operations as the reasoning tasks for a given DL hypothesis as a logical matrix.

13. The hardware-based accelerator as described in claim 10, further comprising:
a circuit for representing outputs of DL operations as the reasoning tasks for a given DL hypothesis as a logical matrix, so that each matrix represents an aspect of the DL knowledge base,
wherein a results matrix represents the outputs of DL operations for a given DL hypothesis,
wherein the DL accesses a concepts matrix,
and wherein a results matrix provides an output storage configuration.

14. The hardware-based accelerator as described in claim 10, further comprising:
a circuit for representing the DL operations as the reasoning tasks for a given DL hypothesis as a logical matrix, wherein each matrix represents an aspect of the DL knowledge base, with a results matrix representing the outputs of DL operations for a given DL hypothesis; and
a circuit for providing a results matrix as an output.

15. The hardware-based accelerator as described in claim 10, wherein the circuit for performing the DL operations performs said DL operations while retrieving input data, and initiates processing of the retrieved data as the retrieve data becomes available without waiting until completion of a burst read operation.

16. The hardware-based accelerator as described in claim 10, wherein using the accelerator provides a hardware configuration to implement the established reasoning tasks provides an acceleration function to accelerate performance for ILP-related computations comprising hypothesis evaluation computations.
